(19) United States
(12) Patent Application Publication
(10) Pub. No.: US 2011/0089307 A1
(43) Pub. Date: Apr. 21, 2011

(54) Support for Hand-Held Instrument

(76) Inventors: Matthew L. Brooks, Falls Church, VA (US); Daniel J. Silverman, Washington, DC (US); Jeffrey S. Brooks, St. Louis, MO (US); Gregory A. Wirtel, (US)

(21) Appl. No.: 12/432,938

(22) Filed: Apr. 30, 2009

Related U.S. Application Data
(60) Provisional application No. 61/049,308, filed on Apr. 30, 2008.

(51) Int. Cl. A47G 1/16; F16M 11/06

(52) U.S. Cl. 248/469; 248/176.3

(57) ABSTRACT

The present invention is directed to a support for hand-held instruments providing for display of an image sheet in both a deployed or in use position and a raised or stored position. The present invention is available for use across a variety of applications that utilize hand-held instrument where an image display is desired. Uses include but are not limited to hand-held device such as writing instruments, toothbrushes, razors, and the like. The present invention provides for a leg assembly positioned near one end of the hand-held instrument, wherein the leg assembly can extend or pivot from the stored position to a use position for the purpose of holding and stabilizing the instrument on a horizontal surface and positioning the instrument in an angled-upward direction to allow for ease of grasp by a user while simultaneously displaying an image within an image holder of the leg assembly.

### CROSS REFERENCE TO RELATED APPLICATIONS

This application claims the benefit of provisional patent application Ser. No. 61/049,308, filed with the USPTO on Apr. 30, 2008, which is herein incorporated by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention generally relates to a stand for hand-held items, more specifically, the present invention relates to a support for hand-held items further comprising an image holder for releasably retaining an image sheet therein.

2. Background Art

The present invention is directed to a support and leg assembly for hand-held instruments providing for display of an image sheet in both a deployed or in use position and a raised or stored position. The present invention is available for use across a variety of applications that utilize hand-held instrument where an image display is desired. Uses include but are not limited to hand-held device such as writing instruments, toothbrushes, razors, and the like. The present invention provides for a leg assembly positioned near one end of the hand-held instrument, wherein the leg assembly can extend or pivot from the stored position to a use position for the purpose of holding and stabilizing the instrument on a horizontal surface and positioning the instrument in an angled-upward direction to allow for ease of grasp by a user and to display an image within an image holder of the leg assembly.

Another disadvantage of traditional instruments is that many do not have stands, which is especially likely if the instrument is disposable. As an example, pen stands are used to support the pen on a horizontal surface, such as a desk, and are typically purchased with relatively expensive writing instruments for positioning and securing the pen in a fixed location and within easy grasp of a user. Some users desire a pen that does not roll across the table and can be secured allowing the user to easily reach for and grasp the pen. Pen stands are especially convenient for users that are handicapped or are required to wear surgical gloves or the like with both user-types having impaired dexterity preventing easy manipulation (e.g. picking up) of the pen in its traditional horizontal resting position. Other instruments, including toothbrushes and razors, may benefit from incorporating a stand there on as well. Elevating one end of such instruments may assist in drying such hygienic devices and preventing functional ends of these devices from contacting potentially contaminating countertops or other undesirable surfaces. When such instruments are using a support or leg assembly to elevate one end of the device, the leg assembly may further act to display an image sheet releasably held within the leg assembly. Such replaceable image sheets may be used for advertising purposes, personal photographs, and the like, as seen fit by the user.

Therefore, it is desirable to provide a support and leg assembly for a hand-held instrument, wherein the leg assembly is designed to provide an image holder for releasably retaining an image sheet for display therein. Hand-held instruments with such a support or leg assembly can be positioned and secured on a horizontal surface to prevent the instrument from rolling off the surface while angling one end of the instrument upward and simultaneously displaying an image sheet.

### BRIEF SUMMARY OF THE INVENTION

In one embodiment of the present invention, a support for a hand-held instrument, the support comprising an image holder for releasably retaining an image sheet in the image holder, wherein the image hold is movable with respect to the hand-held instrument, a pivotal connection disposed between the image holder and the hand-held instrument, wherein the pivotal connection allows the image holder to move from a non-extended position to an extended position in which the image holder projects outward away from the hand-held instrument for contact with a surface on which the hand-held instrument is placed thereby to support the hand-held instrument in a position in which a portion of the hand-held instrument is spaced away from the surface.

### BRIEF DESCRIPTION OF THE DRAWINGS

A better understanding of the present invention will be realized from the detailed description that follows, taken in conjunction with the accompanying drawings, in which:

FIG. 1 is a perspective view illustrating a writing instrument with a support in accordance with the present invention.

FIG. 2 is a side-elevational view illustrating the writing instrument.

FIG. 3 is a top-plan view illustrating the writing instrument.

FIG. 4 is a front-elevational view illustrating the writing instrument.

FIG. 5 is a rear-elevational view illustrating the writing instrument.

FIG. 6 is a perspective view illustrating a second embodiment of a writing instrument according to the present invention having a support shown in a use or supporting configuration.

FIG. 7 is a top-plan view illustrating the second embodiment of the writing instrument in the use configuration with a portion broken away to show a fluid reservoir.

FIG. 8 is a side-elevational view illustrating the second embodiment of the writing instrument in the use configuration.

FIG. 9 is a side-elevational view illustrating the second embodiment of the writing instrument in a stored configuration in solid lines and in the use configuration in phantom lines.

FIG. 10 is a rear-elevational view illustrating the second embodiment of the writing instrument in the use configuration.

FIG. 11 is a front-elevational view illustrating the second embodiment of the writing instrument in the use configuration.

FIG. 12 is an enlarged cross-sectional view, taken along 12-12 of FIG. 10, illustrating a hinge and keeper of the second embodiment of the writing instrument with the support in the use configuration.

FIG. 13 is a perspective view illustrating a third embodiment of a writing instrument according to the present invention in a use configuration.

FIG. 14 is a top-plan view illustrating the third embodiment of the writing instrument in the use configuration.

FIG. 15 is a side-elevational view illustrating the third embodiment of the writing instrument in a stored configuration.

FIG. 16 is a side-elevational view illustrating the third embodiment of the writing instrument in the use configuration.

FIG. 17 is a rear-elevational view illustrating the third embodiment of the writing instrument in the use configuration.

FIG. 18 is a front-elevational view illustrating the third embodiment of the writing instrument in the use configuration.

FIG. 19 is an enlarged cross-sectional view, taken along 19-19, of FIG. 14, illustrating a rack and pinion gear system of the third embodiment of the writing instrument with the support in a use configuration.

FIG. 20 is an enlarged cross-sectional view, taken along 19-19 illustrating the rack and pinion gear system of the third embodiment of the writing instrument with the support in a stored configuration.

FIG. 21 is an enlarged cross-sectional view, taken along 21-21 of FIG. 15, illustrating a rear view of the rack and pinion gear system of the third embodiment of the writing instrument with the support in a stored configuration.

FIG. 22 is a perspective of another embodiment of the writing instrument with a support of the writing instrument in its extended position.

FIG. 23 is a side-elevational view of the writing instrument with the support in its extended position.

FIG. 24 is a rear-elevational view of the writing instrument with the support in its extended position.

FIG. 25 is an elevational view of the writing instrument with the support in its non-extended position.

FIG. 26 is a perspective of another embodiment of the writing instrument illustrating a support of the writing instrument secured to a cap of the instrument and in its non-extended position.

FIG. 27 is similar to FIG. 26 with the cap of the writing instrument exploded from a shaft of the writing instrument.

FIG. 28 is a side-elevational view illustrating the cap secured to a rear end of the writing instrument and the support in its extended position.

FIG. 29 is a perspective of another embodiment of the writing instrument with a support of the writing instrument in its extended position.

FIG. 30 is a side-elevational view of the writing instrument with the support in its extended position.

FIG. 31 is a rear-elevational view of the writing instrument with the support in its extended position.

FIG. 32 is an elevational view of the writing instrument with the support in its non-extended position.

FIG. 33 is a perspective view of a writing instrument of another embodiment with a support of the instrument in a non-extended position;

FIG. 34 is a side elevation of FIG. 33;

FIG. 35 is an exploded view of FIG. 33;

FIG. 36 is a perspective of a cam lever of the support of FIG. 33;

FIG. 37 is a front elevation of the cam lever of FIG. 36;

FIG. 38 is a side elevation of the cam lever of FIG. 36;

FIG. 39 is a perspective of a sleeve of the support of FIG. 33;

FIG. 40 is a front elevation of the sleeve of FIG. 39;

FIG. 41 is a side elevation of the sleeve of FIG. 39;

FIG. 42 is a fragmentary cross section of the support with the cam lever in a non-extended position;

FIG. 43 is similar to FIG. 42 but with the cam lever in an unlocked position;

FIG. 44 similar to FIG. 42 but with the cam lever in an extended, locked position;

FIG. 45 is a side elevation of the writing instrument of FIG. 33 on a horizontal surface and the support in the extended, locked position;

FIG. 46 is a perspective of an image component of the support;

FIG. 47 is a front elevation of the image component;

FIG. 48 is a side elevation of the image component;

FIG. 49 is another embodiment of a writing instrument including an image holder;

FIG. 50 is an exploded view of FIG. 49;

FIG. 51 is an example of a printout of business cards that are sized and shaped to fit one embodiment of an image sheet holder;

FIG. 52 is another embodiment of a writing instrument with a bottle opener secured to a rear end of the instrument;

FIG. 53 is a top perspective view of a toothbrush having a support of the present invention attached to the side of the toothbrush opposite the bristles, wherein the stand is in a deployed position;

FIG. 54 is side view of the embodiment of FIG. 53;

FIG. 55 is a bottom perspective view of the embodiment of FIG. 53;

FIG. 56 is a bottom view of the embodiment of FIG. 53, wherein the stand is in a retracted position;

FIG. 57 is a side view of the embodiment of FIG. 56;

FIG. 58 is a top view of the embodiment of FIG. 56;

FIG. 59 is a top perspective view of a toothbrush having a support of the present invention attached near the midpoint of the side of the toothbrush opposite the bristles, wherein the stand is in a deployed position;

FIG. 60 is side view of the embodiment of FIG. 59;

FIG. 61 is a bottom perspective view of the embodiment of FIG. 59;

FIG. 62 is a bottom view of the embodiment of FIG. 59, wherein the stand is in a retracted position;

FIG. 63 is a side view of the embodiment of FIG. 62;

FIG. 64 is a top view of the embodiment of FIG. 62;

FIG. 65 is side view of a toothbrush having a support of the present invention attached to the same side of the toothbrush as the bristles, wherein the stand is in a deployed position;

FIG. 66 is a top view of the embodiment of FIG. 65;

FIG. 67 is a top perspective view of the embodiment of FIG. 65;

FIG. 68 is a bottom view of the embodiment of FIG. 65, wherein the stand is in a retracted position;

FIG. 69 is a side view of the embodiment of FIG. 68;

FIG. 70 is a top view of the embodiment of FIG. 68;

FIG. 71 is a top perspective view of a razor having a support of the present invention attached to the side of the razor opposite the exposed blades, wherein the stand is in a deployed position;

FIG. 72 is a side view of the embodiment of FIG. 71;

FIG. 73 is a front view of the embodiment of FIG. 71;

FIG. 74 is a bottom view of the embodiment of FIG. 71, wherein the stand is in a retracted position;

FIG. 75 is a side view of the embodiment of FIG. 74;

FIG. 76 is a top view of the embodiment of FIG. 74;

FIG. 77 is a top perspective view of a razor having a support of the present invention attached to the same side of the razor as the exposed blades, wherein the stand is in a deployed position;

FIG. 78 is a side view of the embodiment of FIG. 77; and

FIG. 79 is a front view of the embodiment of FIG. 77.

Corresponding reference characters indicate corresponding parts throughout the drawings.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

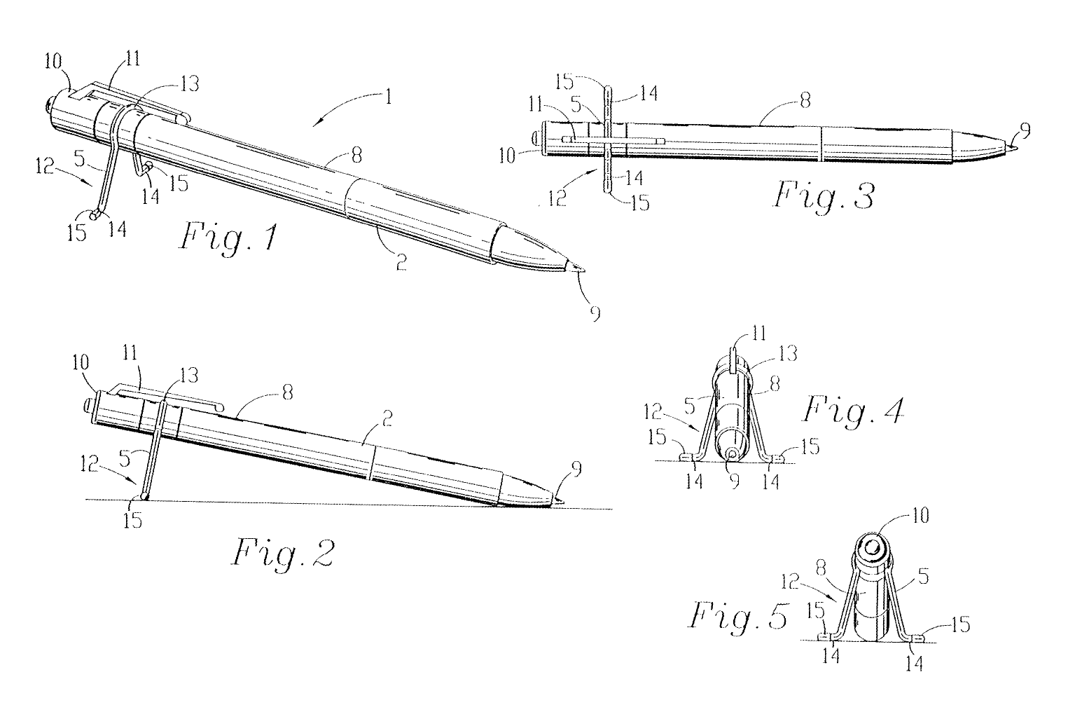

The reference number 1 generally represents a self-supporting coating instrument, more specifically, a fluid dispensing instrument, and more specifically still, a writing instrument in accordance with the present invention and as depicted in FIGS. 1-5. The writing instrument 1 primarily consists of an elongated body 2 and a detachable support 5 that are assembled after manufacture allowing for the detachable support 5 to be used with a number of different shaped bodies. The detachable support 5 engages the body 2 at one end of a shaft 8 opposite a writing end 9 (broadly, a coating tip) near a distal or rear end 10. The support 5 can be used in combination with a traditional pen clip 11, as shown and which are well-known in the art, so as to not detract from the operation and use of the clip 11.

In the preferred embodiment, the support 5 is constructed of an elongated wire, but it is foreseen that another like material such as plastic can be utilized providing that the material properties include sufficient resiliency and memory to be able to flex and spring around a shaft of a coating instrument and snap back and return to its original configuration at a central C-shaped region sized and shaped to snugly surround the shaft.

The detachable support has legs 12 extending outward from the C-shaped region 13. The legs 12 are spaced in relationship with one another and diverge outwardly away from the body 2 to provide a triangular support system to the writing instrument 1. The C-shaped region 13 is designed to receive various shafts having a common or conventional width that are found among writing instruments 1, which is approximately ⅜ inches diameter. The C-shaped region 13 is designed to engage the shaft 8 by flexing outward and then snapping around the shaft 8.

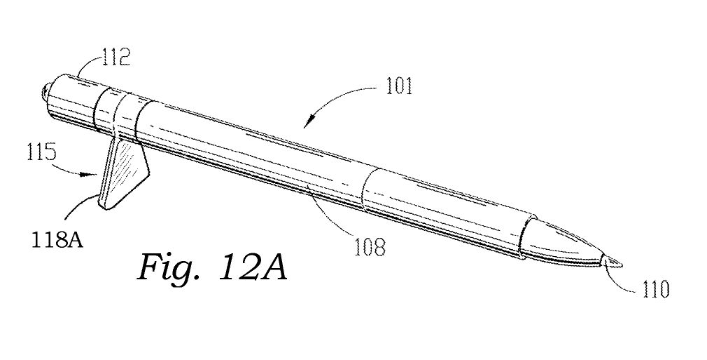

It is foreseen that a support could utilize a number of designs such as a single relatively wide leg or a single leg with a relatively wide base having a V shape (FIG. 12A) or U shape. Also foreseen is a support that is connected to a writing instrument cap, which can be selectively placed on either end of a writing instrument shaft having a support that provides sufficient stability for the intended supporting function of the present invention.

At the lower or distal end of each leg 12 is an outwardly extending foot 14. Located on ends of each foot 14 are rubber or plastic balls or pads 15 to provide friction on a non-slip surface upon engagement with a horizontal surface or something of the like and to prevent the support 5 from scratching the horizontal surface. While it is foreseen that a number of other materials could be utilized to form the pads 15, the pads 15 are ideally manufactured by dipping the tips of the legs 12 into liquid polyurethane.

The writing instrument 1 is especially advantageous for use in applications requiring a plethora of different liquids of various colors, viscosities and textures, along with different marking or fluid dispensing tips, etc., which require a user to sporadically switch back and forth between the liquids and tips during operation. While archaic instruments, which are designed to be laid flat on a table or the like, would require the user to shake the instrument to bias the liquid toward the marking end of the instrument when use is desired, the present invention provides the user with writing instruments 1 that are readily useable. Although the illustrated coating instrument is a writing instrument 1 for dispensing ink, other types of coating instruments, including other types of writing instruments, such as pencils and markers, are within the scope of the present invention. The coating instrument of the present invention may be designed to dispense fluid medication, such as medication for treating ailments of the skin. Moreover, the coating instrument may be an X-ray marker for marking on a radiograph or a marker for writing on a patient's skin. Other types of coating instruments are within the scope of the present invention.

Furthermore, if the user is operating on a surface that is not horizontal, such as an architect's desk, the present invention provides the user with coating instruments that can be secured in one position, thus preventing undesired migration of the instrument across the surface.

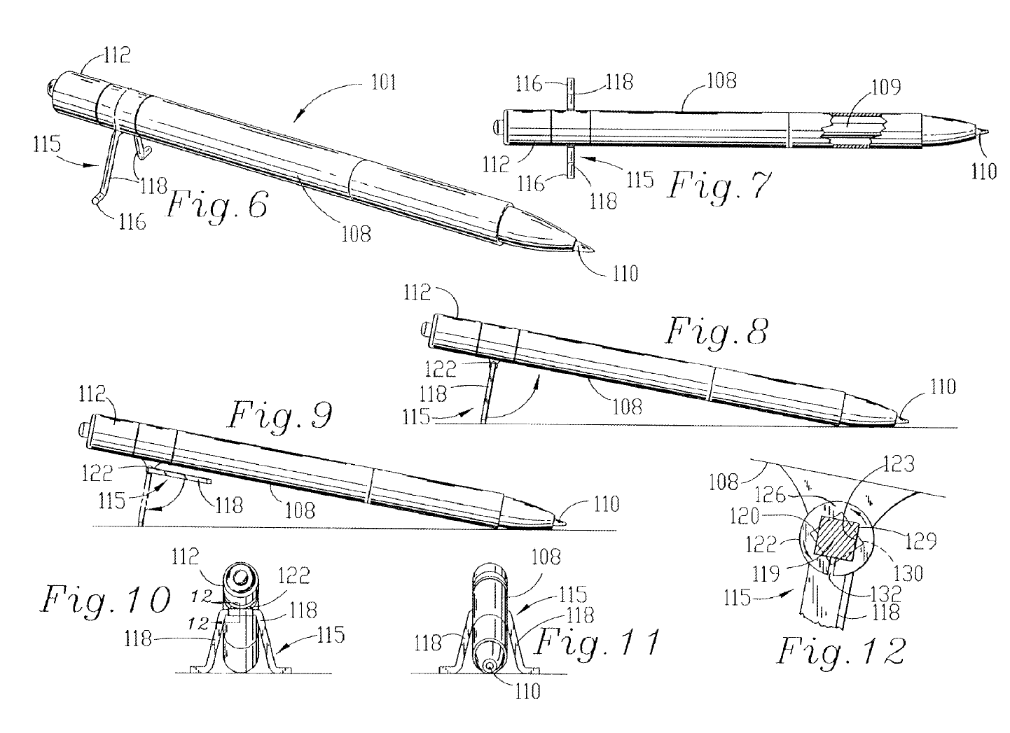

In a second embodiment as depicted in FIGS. 6-12, a hinged, self-supporting writing instrument 101 has an elongated shaft 108 with a fluid dispensing or writing tip or end 110 at one extremity of the shaft 108. Within the shaft 108 is a coating or liquid reservoir 109 that flow-communicates with the writing end 110.

Opposite the writing end 110 of the shaft 108 near a distal or rear end 112 is a support 115. In the present embodiment, the support 115 is integrated with or pivotally joined to the shaft 108 during manufacture of the writing instrument 101. The support 115 has legs 118 joined by a bar 119 having shaft-engagement surface 120. At the lower or distal end of each leg 118 is an outwardly extending foot 116. As depicted in FIG. 12, the bar 119 is square in cross section and is attached to the distal end 112 of the shaft 108 via a flexible keeper 122, having an interior surface 123 that is snugly mateable with the keeper 122 when in a relaxed configuration. The keeper 122 is flexible and can be biased to a stretched configuration by applying manual pressure rotational to the support 115. In this manner, the bar 119 rotates in the keeper 122 between a first stable position seen in FIG. 9 in solid lines wherein the support 115 is in a non-extended position and a second stable position seen in FIG. 9 in phantom lines wherein the support 115 is in an extended and supporting position. The keeper 122 springs or flexes outwardly under pressure to allow the support 115 to move between the position described, but returns to snugly cradle the support 115 in a desired position, once that position is obtained. In particular, the keeper 122 allows the legs 118 to pivot away from and alternatively toward the shaft 108 in order to alternate from a stored configuration to a use configuration. In the use configuration, the support legs 118 extend or pivot away from the shaft 108 to a preselected angle such as ninety degrees in order to form a tripod configuration with the coating end 110.

It is foreseen that the keeper 122 forming a hinge with the bar 119 could be constructed with a clip that goes around a shaft so that a leg or legs may pivot relative to the shaft. It is also foreseen that the keeper 122 forming a hinge, as depicted in FIG. 9, could be located on the opposite side of a shaft so that when converting from a storage to a use configuration, a leg or legs pivot toward and straddle the shaft as opposed to away from the shaft as depicted in FIG. 9. In either instance, the clip and/or legs would flex and spring around a shaft and snap back and return to its original configuration or may be more rigid and slide along the shaft from one end thereof into a desired locator. Where resistance is required, the support may be constructed of a material that is sufficiently resilient and has memory.

In the use configuration, as depicted in FIG. 8, the writing instrument 101 can be placed on a horizontal surface while the distal end 112 is propped upward within easy grasp of a user and an interior reservoir 109, located within the shaft 108 as depicted in FIG. 7, is extended upwardly above the writing end 110, thus utilizing gravity to bias the fluid contents of the reservoir 109 toward the marking end 110 of the instrument 101 to provide an instrument 101 that is readily graspable and useable. In the stored position, as depicted in solid lines in FIG. 9, the legs 118 pivot to extend alongside and generally parallel to the reservoir 109 and shaft 108 at a preselected angle, such as zero degrees. The present embodiment provides space between the shaft 108 and the legs 118 in order to allow the legs 118 to act as a traditional pen clip. However, it is foreseen that in some embodiments, that a support could be provided that is flush mounted to a shaft with the shaft having an outer surface that corresponds to the support with the support designed to fold outward.

In either configuration, the writing instrument 101 is designed to provide two stabilized positions at a selected angular configuration with respect to the shaft 108. While it is foreseen that stabilization can be achieved with a number of designs, the present embodiment utilizes a spring-loaded outward C-shaped member 126 with the interior surface 123 that engages the shaft-engagement surface 119 and is located within the keeper 122, as depicted in FIG. 12. The shaft-engagement surface 119 has a rectangular surface 129 that matingly engages and aligns with a corresponding mating surface 130 of the keeper interior surface 126. The surfaces 129 and 130 have sufficient resiliency so that the support surface 129 can rotate within the mating surface 130 with the application of force. Specifically, the application of pressure overcomes and biases out the keeper 126 allowing rotation of the shaft-engagement surface 119 and pivoting of the legs 118. A flex channel 132 is located within the keeper 122. The bar 119 is initially inserted in the keeper 122 by forcibly spreading opposites sides thereof at the flex channel 132 and urging the bar 119 there through.

Referring to FIG. 12A, in another example of the second embodiment of the writing instrument 101, the support 115 comprises a single leg 118A with a relatively wide base having a V shape. The use and function of the single leg 118A is similar to the use and function of the pair of legs 118 depicted in FIGS. 6-12 and described above.

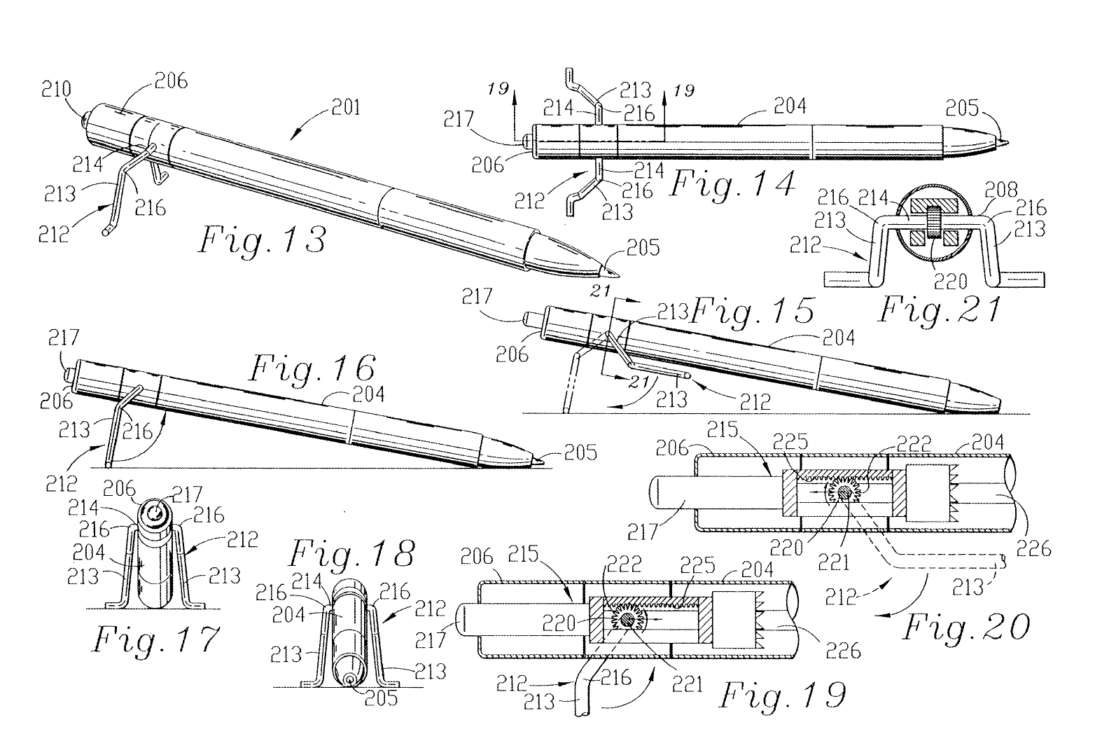

A third embodiment, depicted in FIGS. 13-21, consists of an integrated, writing instrument 201 which is a push-button actuated pen having an elongated shaft 204 and a marking or writing end 205 that is opposite a distal or rear end 206. The present embodiment has a support 212 near the distal end 206 with legs 213 and a cross bar 214 spacing and connecting the legs 213. Each of the legs 213 is bent at an elbow 216, so as to operably space the lower portion of the legs 213 near and parallel but away from the shaft 204 in a stored configuration such as is seen in solid lines in FIG. 15. The bar 214 is integrated into and operates cooperatively with a push-button mechanism 215 for the instrument 201. Specifically, the instrument 201 operates by depressing a button 217 to either extend or retract a writing or marking tip 205. The present embodiment adds a pinion gear 220 with a center axis 221 within the shaft 204 near the distal end 206, as depicted in FIGS. 19-21, that cooperatively engages the bar 214 of the support 212. The bar 214 passes through the center axis 221 of the pinion gear 220. The pinion gear 220 has a toothed outer rim 222 that engages and a rack 225 that is operably located between the push button 217 and a fluid reservoir 226. As the push button 217 is operated, the rack 225 jogs back and forth toward rear and front within the shaft 204, which causes the pinion gear 220 to spin. The pinion gear 220 causes the bar 214 to rotate, which causes the legs 213 to pivot back and forth between the stored configuration, as depicted in FIG. 15, and a use configuration, as depicted in FIG. 16.

In the use configuration, the writing instrument 201 can be placed on a horizontal surface while the distal end 206 is propped upward within easy grasp of a user and the reservoir 226, which is located within the shaft 204, as depicted in FIGS. 19 and 20, is located above the writing end 205, thus utilizing gravity to bias the fluid contents of the reservoir 226 toward the writing end 205 of the instrument 201 so that the instrument 201 is both readily graspable and immediately useable.

In the stored position, as depicted in FIG. 15, the legs 213 pivot so as to extend alongside and parallel to the shaft 204 so that the legs 213 of the support 212 may be used as a traditional pen clip for holding in a pocket or the like. Further, the legs 213 are swept backwards at an angle to provide a traditional pen clip function when the support 212 is in the stored configuration.

In either configuration, the self-supporting writing instrument 201 is designed to provide two stabilized positions at selected angular locations relative to the shaft 204.

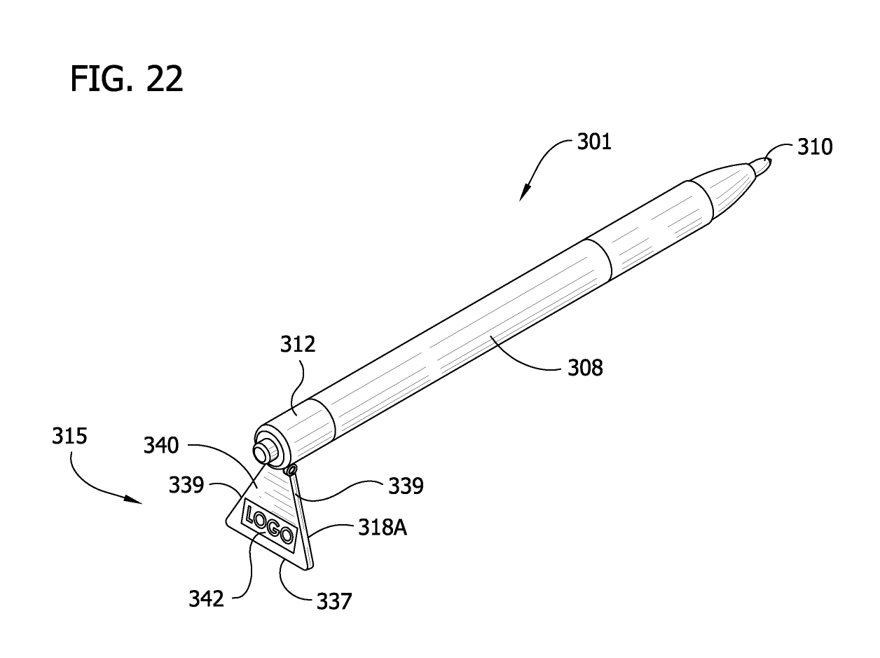

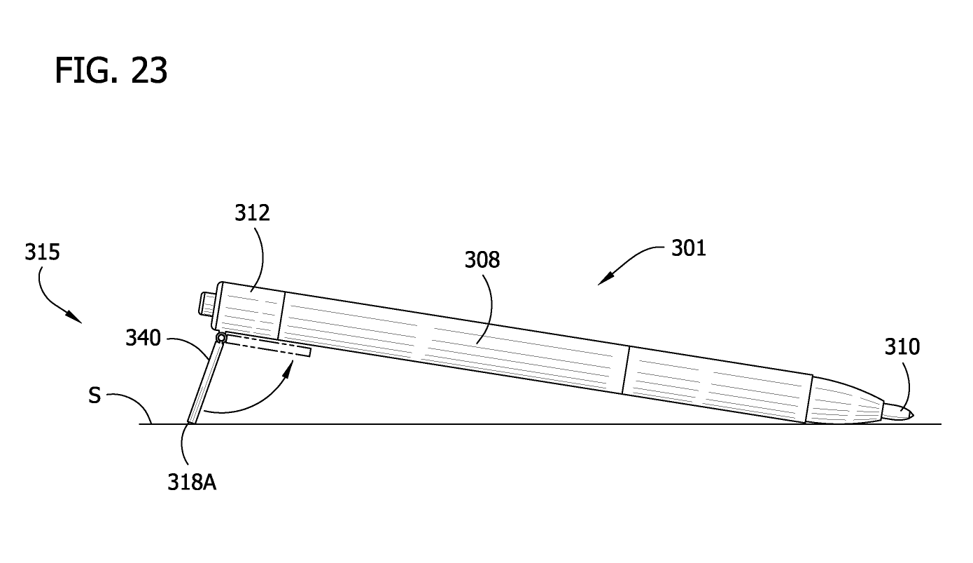

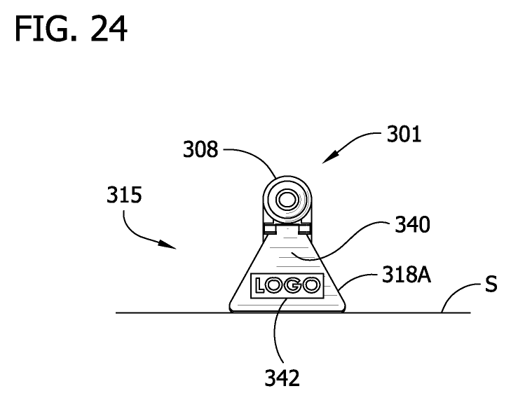

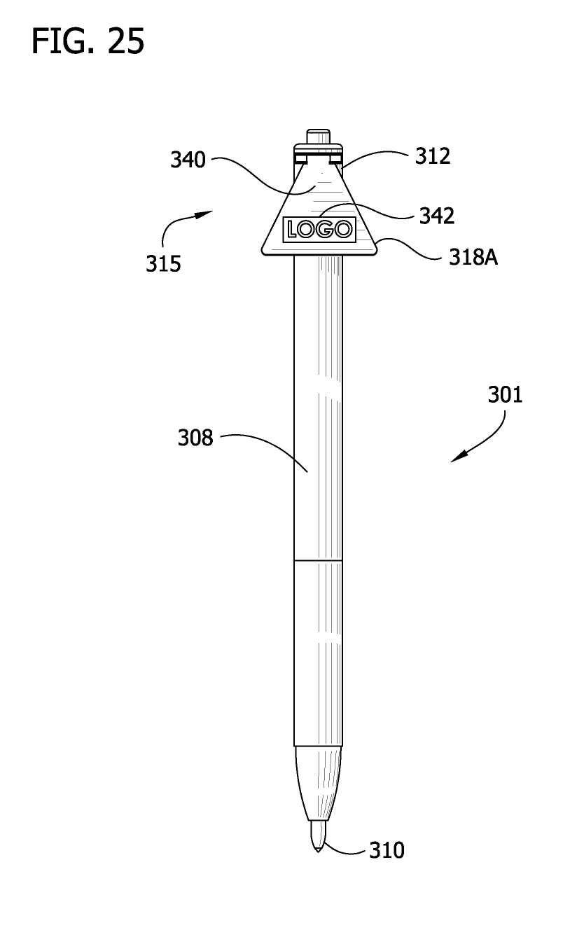

Referring to FIGS. 22-25, another embodiment of the writing instrument, generally indicated at 301 is similar to the embodiments illustrated in FIGS. 6-12A, and therefore, like components are indicated by corresponding reference numerals plus 200. The present embodiment is most similar to the embodiment in FIG. 12A in that the writing instrument includes a support 315 comprising a single leg 318A having a relatively wide base 337 and tapered side edges 339. The support 315 is pivotally secured adjacent to a rear end 312 of the shaft 308 of the writing instrument 301 in a manner similar to that taught by the embodiments illustrated in FIGS. 6-12A. It is understood that the support 315 may be pivotally secured or pivotally securable to the writing instrument 301 in other ways, including the ways taught by the other embodiments of the present invention. Like the support 115 in FIG. 12A, the present support 315 is movable between an extended position, in which the support projects outward away from the shaft 308 for contact with a surface S on which the instrument is placed (FIGS. 23 and 24), and a non-extended position (FIG. 25), in which the support can function as a traditional clip for attaching the writing instrument to a pocket, for example. In the illustrated embodiment, when the support 315 is in the extended position and is contacting the surface S to support the writing instrument, the writing or fluid dispensing tip 310 and a portion of the shaft 308 are spaced from the surface.

An outer, generally planar face 340 of the support 315, which faces away from the shaft 308 of the writing instrument 301 when the support is in its non-extended position, includes an advertising image 342 that is imprinted or formed on or otherwise affixed to it. For example, the advertising image 342 may be a computer generated image that is created on a substrate with an adhesive backing that is adhered to the support 315. Alternatively, the advertising image 342 may be formed (e.g., molded) directly on the support 315. Other ways of affixing or forming the image 342 are within the scope of the invention. It is understood that the support may be of a shape or type other than a solid, generally triangular member. For example, the support can comprise a pair of collapsible legs, and the advertising image can be affixed to or otherwise formed on a pliable substrate extending between the collapsible legs so that when the legs are in the non-extended position, the advertising image faces outward away from the shaft. In another example, the pliable substrate on which the advertising image is disposed can have an end secured to an end of the support and an opposite end secured to the shaft of the writing instrument so that when the support is in the non-extended position, the advertising image faces outward away from the shaft. Other types of supports and other ways of disposing the advertising image on the support are within the scope of the invention.

In the illustrated embodiment, the advertising image 342 is a graphic image of a logo of a company or organization. It is understood that the advertising image 342 may comprise one or more of a logo, motto, trademark, trade name or any other type of advertising and/or marketing of a company or organization. As is readily apparent from the drawings, the advertising image 342 on the outer face 340 of the support 315 is readily visible whether the support is in its extended position and contacting a surface S to support the writing instrument 301 (FIGS. 22 and 24) or its non-extended position (FIG. 25).

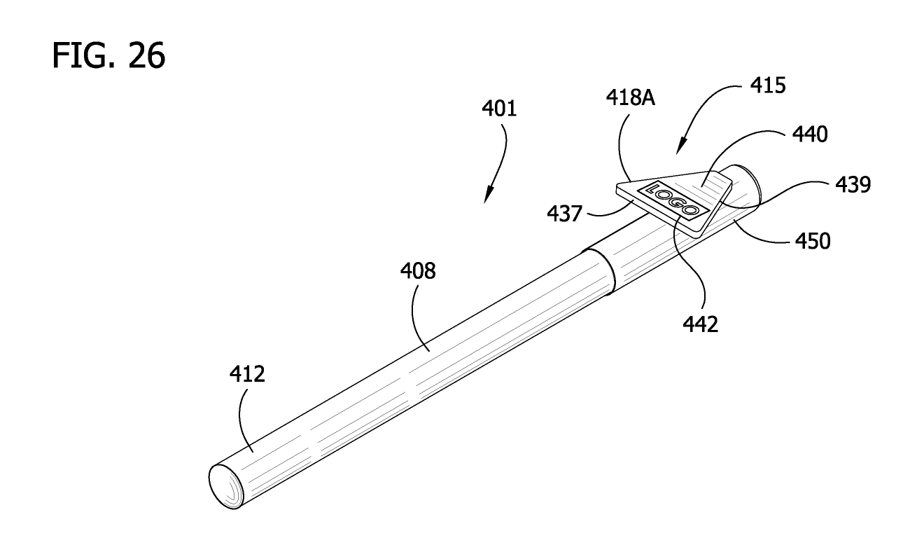

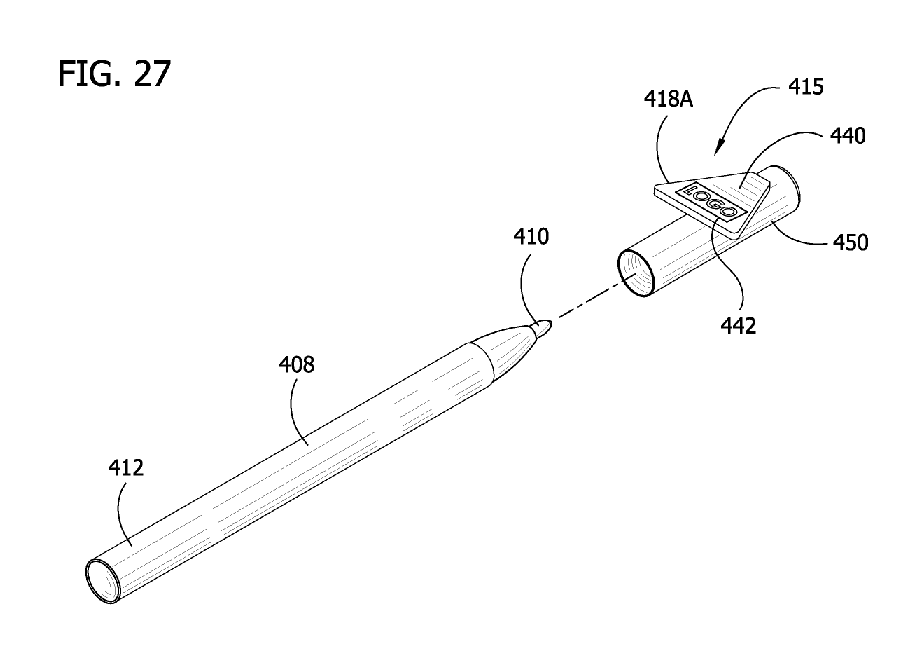

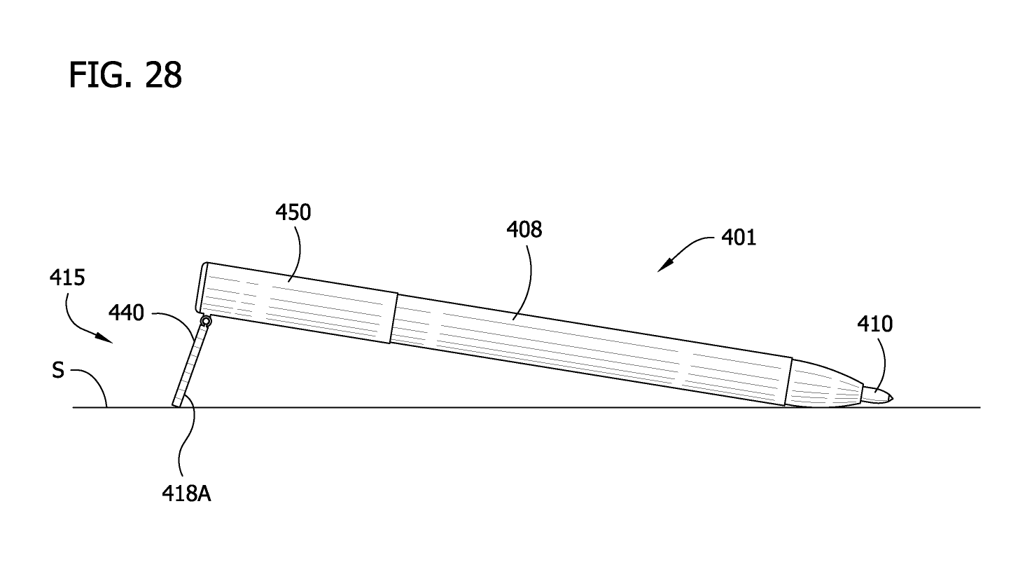

Referring to FIGS. 26-29, in another embodiment that is similar to the embodiment of FIGS. 22-25 and has like components indicated by corresponding reference numerals plus 100, the writing instrument 401 includes a support 415 that is pivotally secured to a cap 450 of the writing instrument. The cap 450 is removably securable to the writing end of the writing instrument over the writing tip (FIGS. 26 and 27) and is removably securable over the rear end 412 of the instrument (FIG. 28). Thus, when the cap 450 is secured over the tip 410 of the writing instrument 401 (FIG. 26), the support 415 may be positioned in its non-extended position and may operate as a clip with the advertising image 442 being readily visible. Moreover, referring to FIG. 28, when the cap 450 is removed from the writing end and received on the opposite, rear end 412 of the writing instrument 401, the support 415 may be positioned in its extended position whereby the writing instrument can be placed on the surface S so that the support contacts the surface to support the shaft 408 in a position in which a portion of the shaft is spaced away from the surface. The advertising image 442 is readily visible when viewing the writing instrument from the rear.

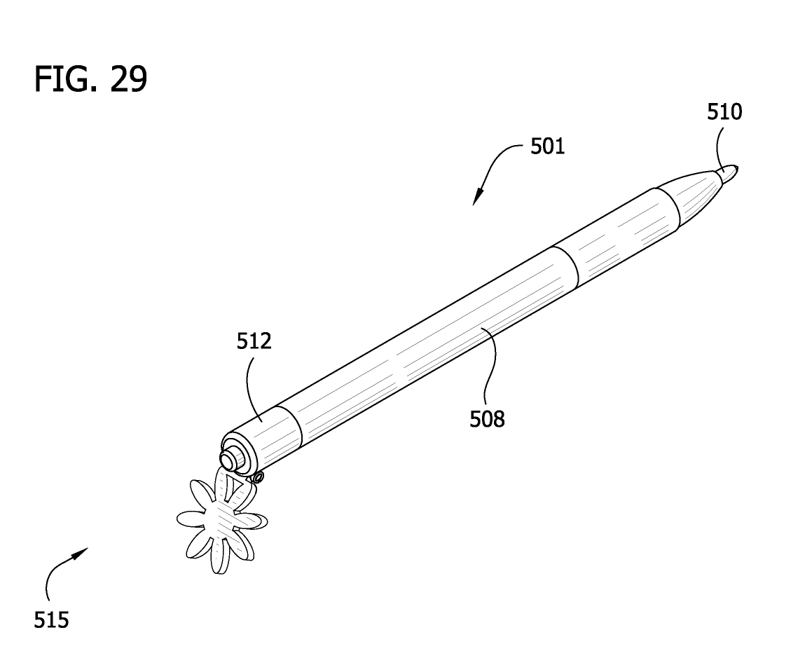

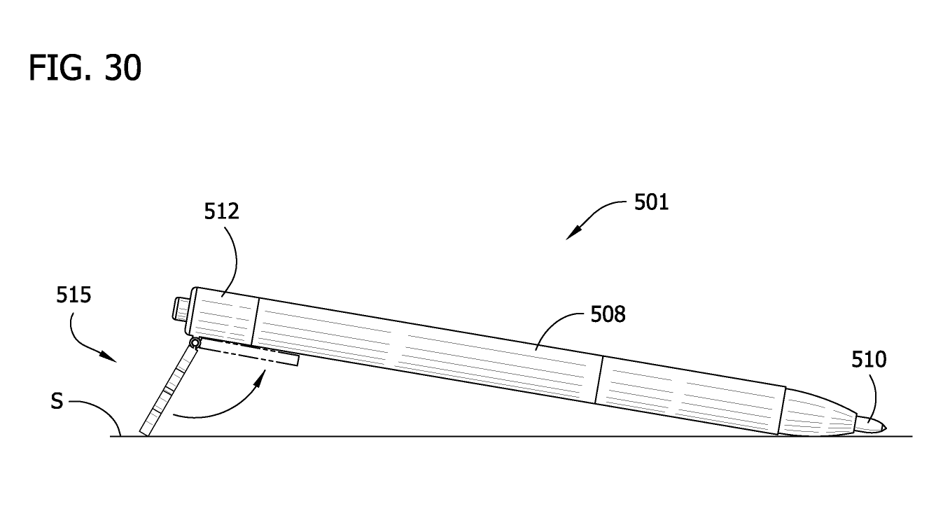

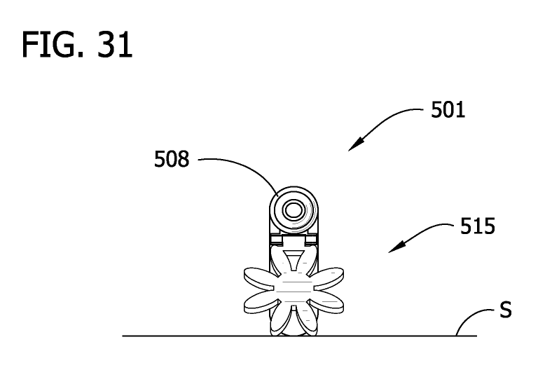

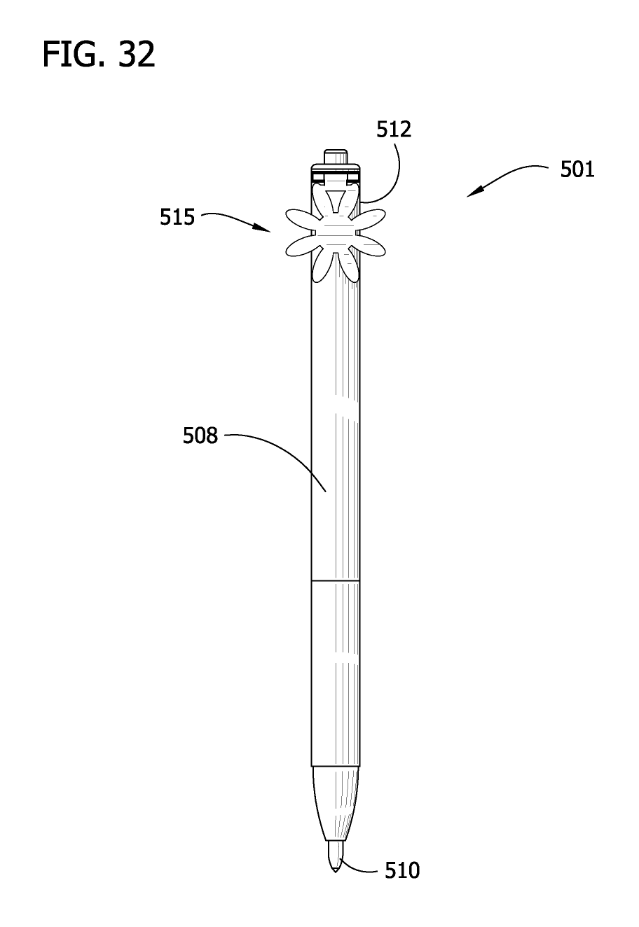

Referring to FIGS. 29-32, in yet another embodiment that is similar to the embodiment of FIGS. 22-25 and has like components indicated by corresponding reference numerals plus 200, the writing instrument 501 includes a support 515 that is formed as the advertising image. In this embodiment, the periphery of the support 515 may be coincident with the periphery of the advertising image and/or the support may take the three-dimensional form of the advertising image. Moreover, the outer face of the support may not be planar so as to further define contours of a three-dimensional image. In the illustrated embodiment, the support 515 is formed as a three-dimensional asterisk, representing a logo of a company. Although the illustrated support 515 is pivotally secured to the shaft 508 of the writing instrument 501, it is understood that it may be secured to other components of the writing instrument, such as a cap, similar to the embodiment of FIGS. 26-28. Moreover, although the support 515 is pivotally secured to the shaft 508 in a similar manner as shown in FIGS. 6-12A, it is understood that it may be secured to the shaft or cap or other component of the writing instrument in other ways without departing from the scope of the invention.

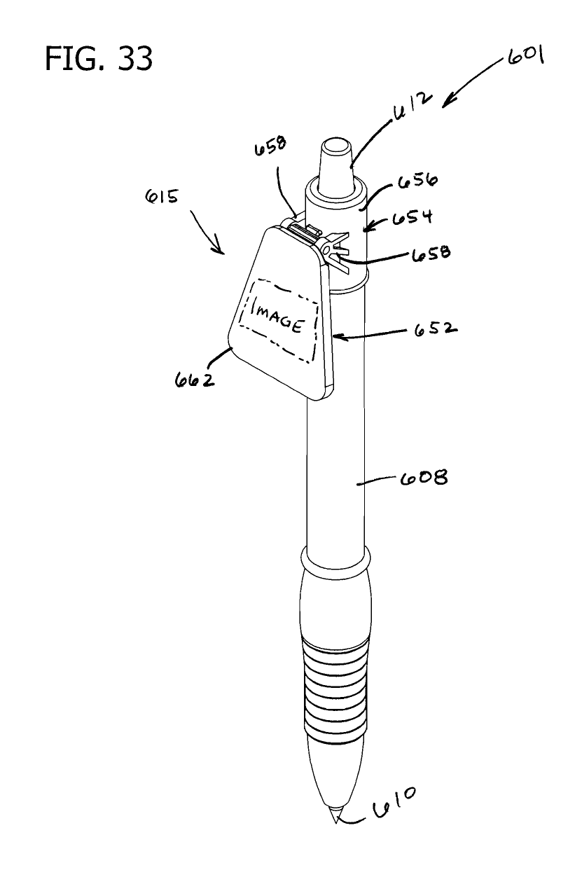

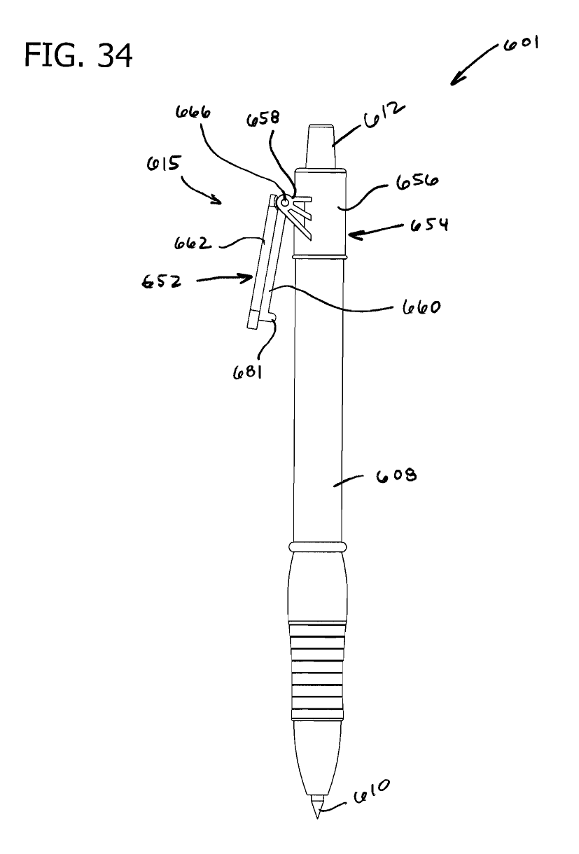

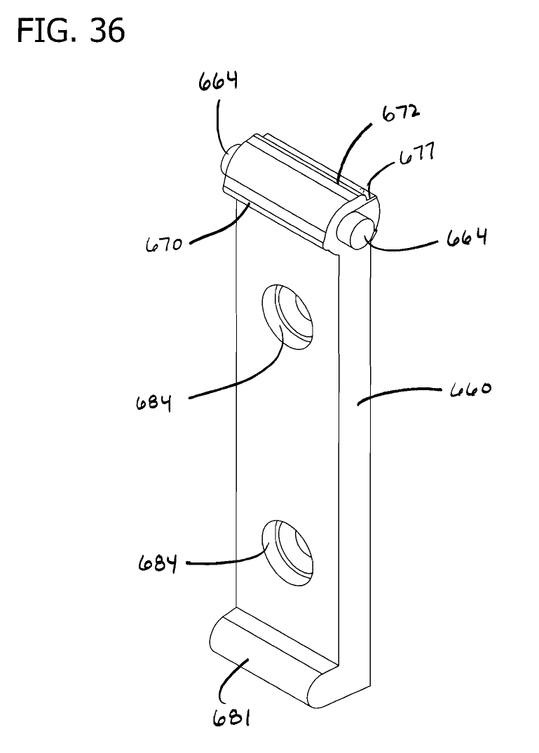

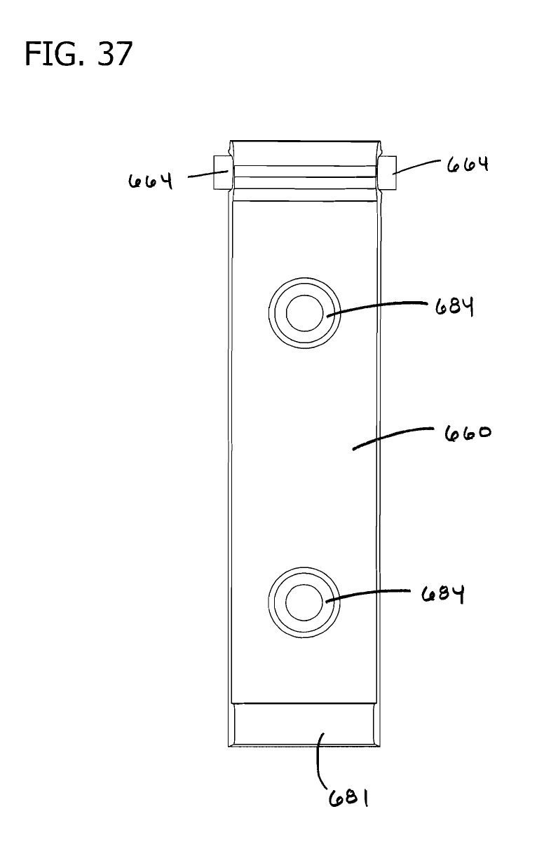

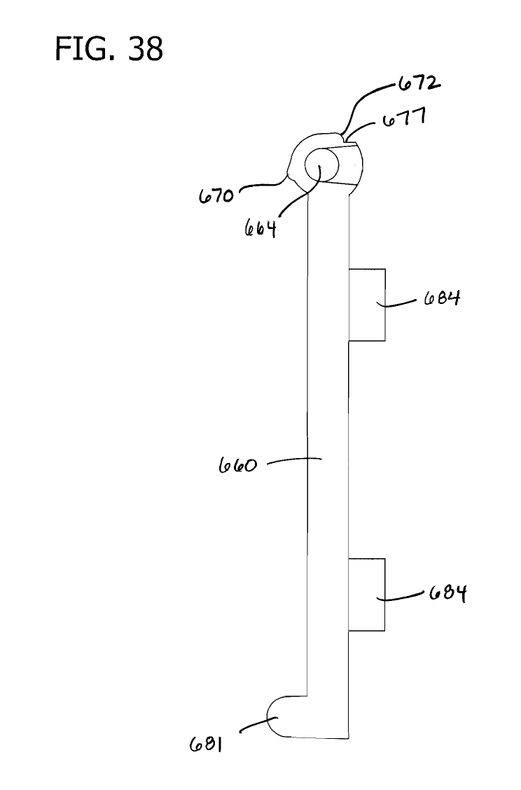

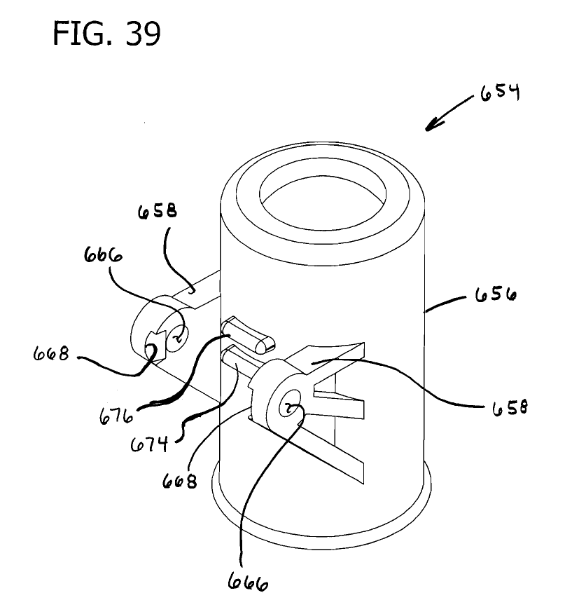

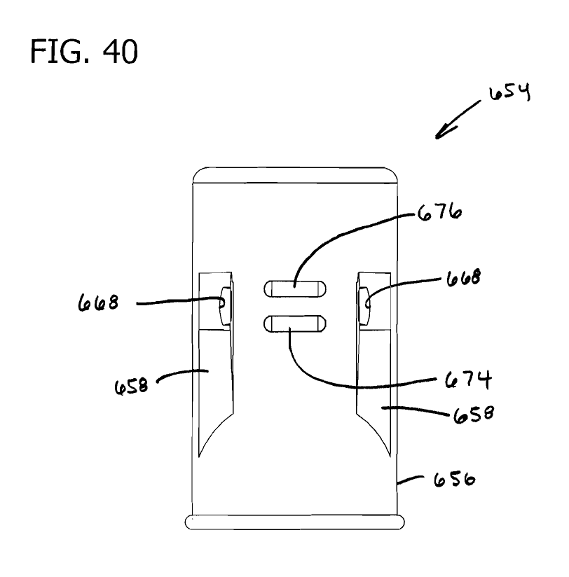

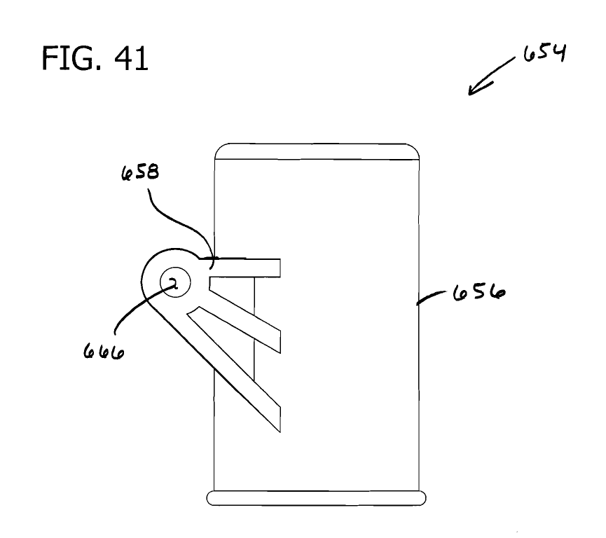

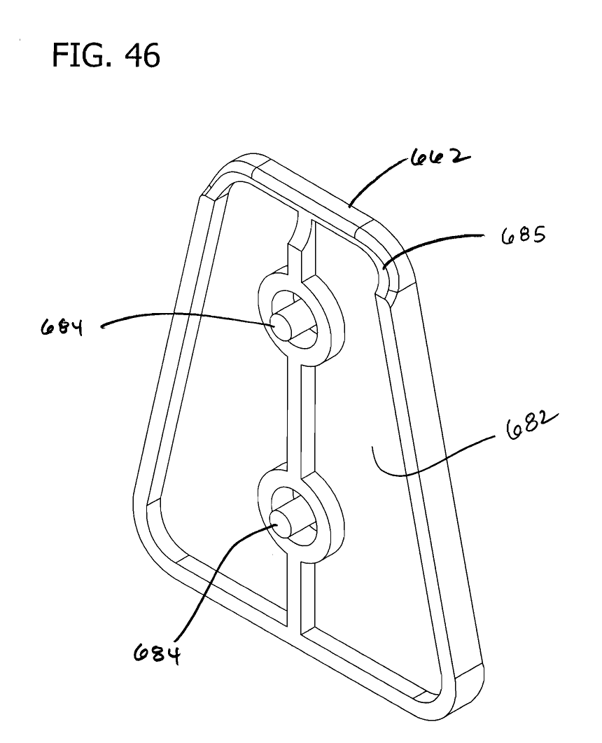

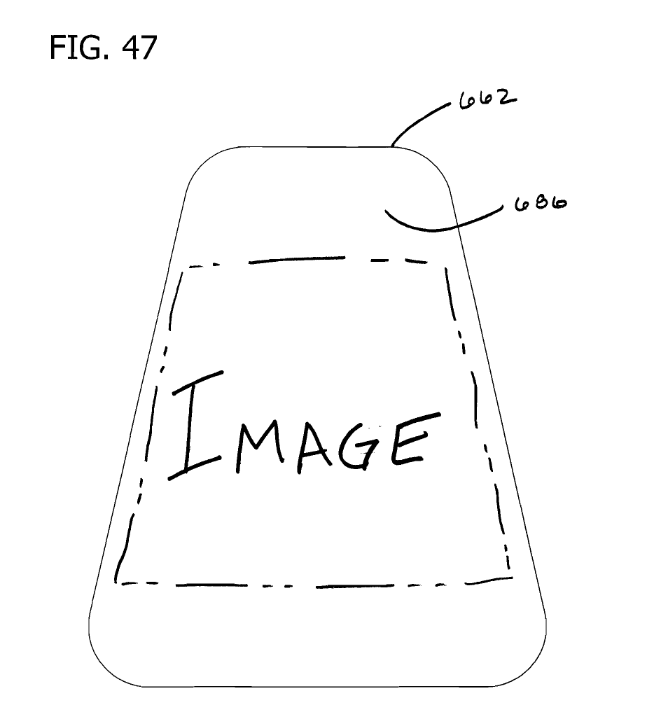

It is understood that the hinge mechanism by which the leg of the support is pivotable relative to the shaft or cap of the writing instrument may be of other configurations without departing from the scope of the present invention. For example, referring to FIGS. 33-48, a writing instrument 601 includes a cam-action hinge mechanism, as will be explained below. This writing instrument 601 is similar to the writing instrument 301 of FIGS. 22-25 and has like components indicated by corresponding reference numerals plus 300. All arrow lead lines indicate that corresponding parts are being indicated generally. A support 615 of the instrument 601 comprises a leg assembly 652 (broadly, a leg) hinged to a leg connector 654 which is secured to a shaft 608 of the writing instrument. In the illustrated embodiment, the leg connector 654 comprises a sleeve 656 that is sized and shaped to slide onto the shaft 608 of the instrument 601, and more particularly, to slide onto a rear end 612 of the shaft opposite a tip 610. A leg mount comprising a pair of arms 658 is integrally formed with and extends outward from the sleeve 656.

The leg assembly 652 comprises a cam lever 660 (broadly, a leg) hingedly secured to the arms 658 and an image component 662 (broadly, a leg component) secured to the cam lever. The cam lever 660 includes integrally formed pins 664 at a first or attached end of the cam lever that secure by snap-fit connection in openings 666 in the arms 658. Grooves 668 extending radially outward from the openings 666 in the arms 658 guide the pins 664 into the respective openings. The pins 664 are rotatable within the openings 666 so that the leg assembly 652 is pivotable relative to the arms 658 about an axis spaced radially outward from and generally perpendicular to the longitudinal axis of the sleeve. Other ways of hingedly securing the cam lever 660, or the leg assembly 652 in general, to the sleeve 656 or the shaft 608 of the instrument 601 are within the scope of the invention. For example, a hinge pin separate from the cam lever may extend through the cam lever and the openings in the arms. Other connections are within the scope of the invention.

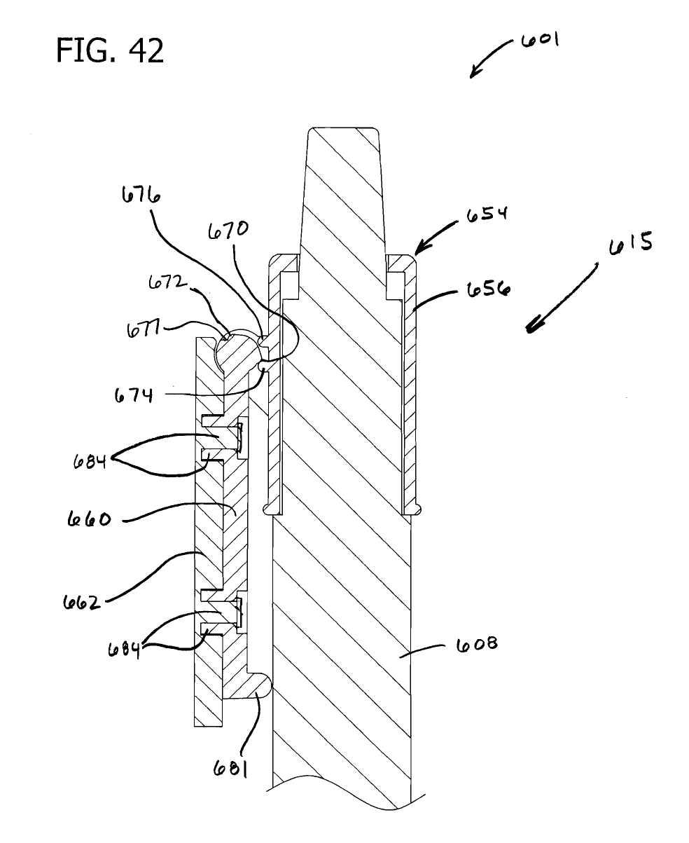

Referring to FIGS. 42-44, the leg assembly 652 of the illustrated writing instrument 601 is selectively lockable in both its retracted (non-extended) position and its extended position by a detent mechanism. The detent mechanism includes lower and upper cam surfaces 670, 672, respectively, on the cam lever and lower and upper cam followers 674, 676 integrally formed on the leg connector 654. The lower cam surface 670 is engageable with a lower cam follower 674, and the upper cam surface 672 is engageable with an upper cam follower 676. In the illustrated embodiment, the lower and upper cam followers 674, 676, respectively, comprise a pair of spaced apart upper and lower ribs.

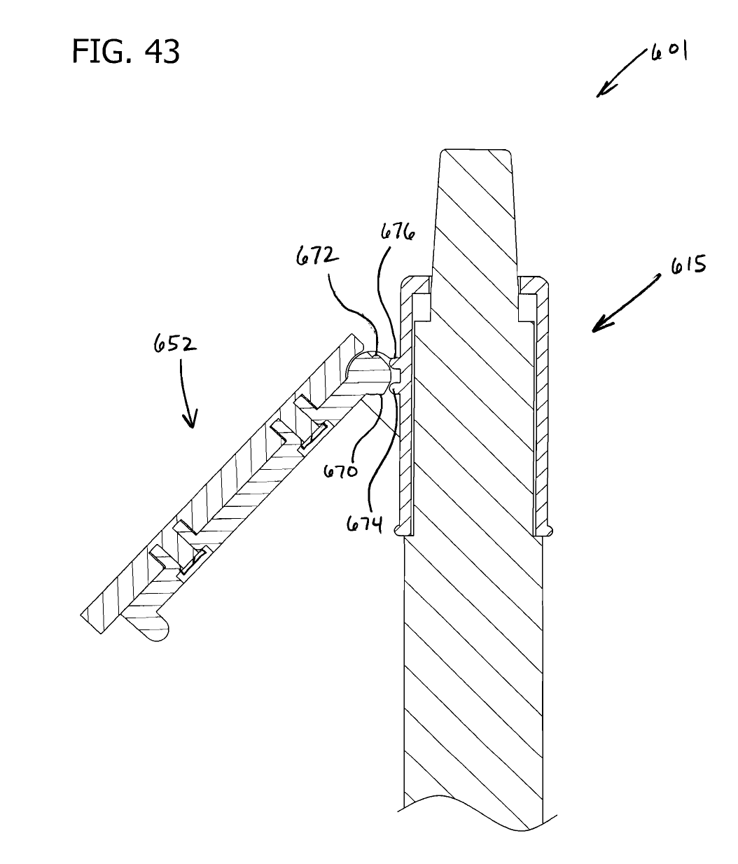

The lower cam surface 670 and lower cam follower 674 are configured to selectively lock the leg assembly 652 in the non-extended position. When the leg assembly 652 is in its non-extended position (FIG. 42), the lower cam surface 670 is over-center with respect to the lower cam follower 674 so that frictional engagement between the lower cam surface and the lower cam follower resists pivotable movement of the leg assembly (i.e., the cam lever 660) away from the pen shaft 608. The cam lever 660 will pivot away from the pen shaft 608 if adequate torque is applied to the cam lever to resiliently deflect at least one of the cam lever and the cam follower and to overcome the frictional resistance between the lower cam surface 670 and the lower cam follower 676. A projection 681 on the cam lever extends toward the shaft 608 and engages the shaft when the cam lever is in the non-extended position so that the cam lever and the image component are generally parallel to the shaft, as shown best in FIG. 42. When the cam lever 660 is pivoted to an unlocked angular position relative to the sleeve 656, such as shown in FIG. 43, the lower cam surface 670 disengages the lower cam follower 674, and the cam lever and the leg assembly 652 are unlocked and free to rotate.

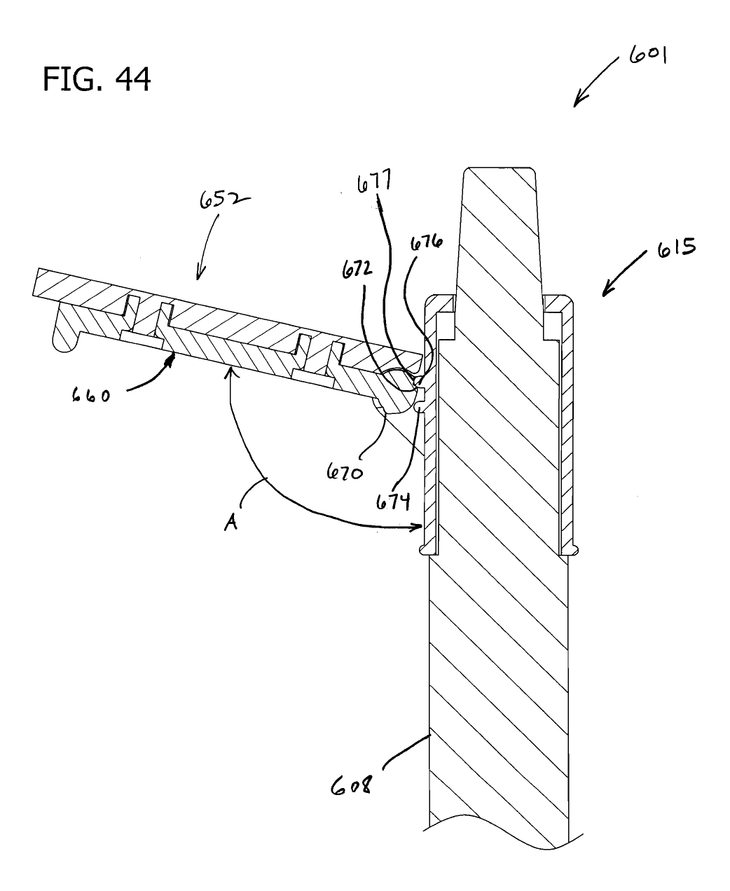

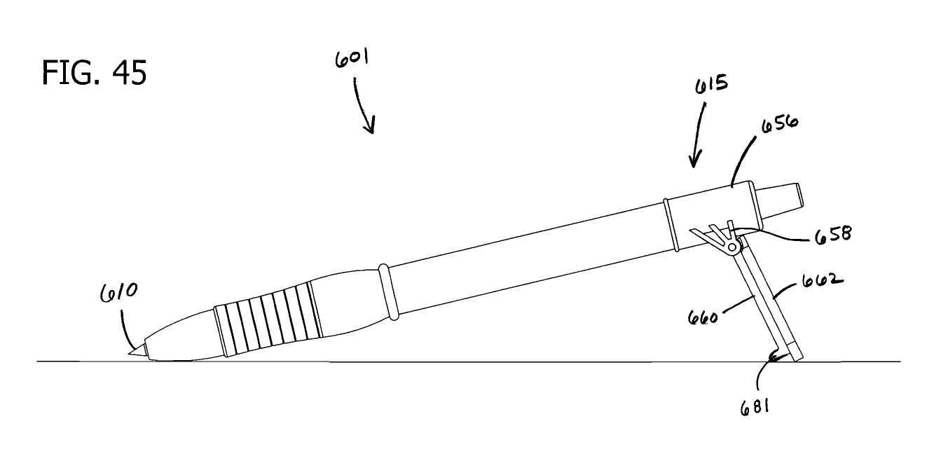

Referring to FIG. 44, the upper cam surface 672 and the upper cam follower 676 are configured to selectively lock the leg assembly 652 in the extended position. Pivoting the cam lever 660 further away from the shaft 608, past the unlocked angular position, will cause the upper cam surface 672 to engage the upper cam follower 676. The cam lever 660 will pivot away from the shaft 608 if adequate torque is applied to the cam lever to resiliently deflect at least one of the cam lever and the cam follower and to overcome the frictional resistance between the upper cam surface 672 and the upper cam follower 676. In an extended, locked position, such as shown in FIG. 44, the upper cam surface 672 is over-center with respect to the upper cam follower 676 so frictional engagement between the upper cam surface and the upper cam follower resists pivotable movement of the leg assembly 652 (i.e., the cam lever) toward the shaft 608. Moreover, at the extended position, the upper cam follower 676 is received in a recess comprising a notch 677 formed in the upper surface 678 of the cam lever, past the upper cam surface 672, to prevent the leg assembly from pivoting past the extended position. The projection 681 also contacts the horizontal surface when the support 615 is in its extended position (FIG. 45) to further prevent the leg assembly 652 from pivoting past the extended position. Other detent mechanisms or the like can be used to releasably hold the leg assembly in its retracted and extended positions.

In the illustrated embodiment, the leg assembly 652 is in the locked, extended position when the cam lever 660 extends outward from the sleeve 656 and the shaft 608 is at an angle A (FIG. 44) that measures about 103 degrees. The angle A may measure other than 103 degrees. For example, it is contemplated that this angle A may be greater than or equal to about 90 degrees. More specifically, the angle A may be greater than 100 degrees, such as 101 degrees, 102 degrees, 103 degrees, 104 degrees, 105 degrees, 106 degrees, 107 degrees, 108 degrees, 109 degrees or 110 degrees. Further, in the illustrated embodiment, when the support 615 is in the locked, extended position and is supporting the instrument 601 on a surface, the tip 610 of the instrument is preferably about 0.39 in (1 cm) above the surface and the rear end 612 of the shaft 608 at the hinge mechanism is between about 0.9 in (2.27 cm) and about 1 inch (2.54 cm) above the surface.

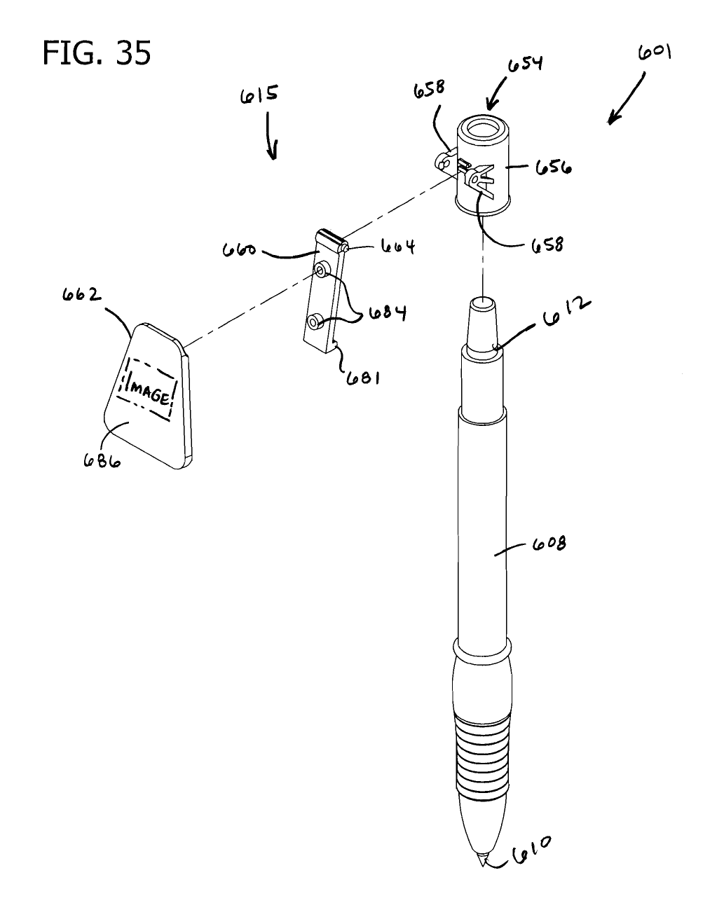

Referring to FIG. 35, the sleeve 656 is configured so that the instrument 601 can be retrofitted with the support 615. Accordingly, the size and shape of the sleeve 656 may be dependent on the type and brand of writing instrument 601 being retrofitted. It is contemplated that the leg connector 654 may alternatively comprise a clip-on type connector adapted to be clipped on or otherwise secured to the writing instrument 601 so that a single support can be retrofitted on different types and brands of writing instruments. It is also contemplated that the leg connector may alternatively comprise a male component that is inserted into an opening in the rear end 612 of the writing instrument to connect the support to the instrument. The leg connector may be of other configurations for connecting the support to the instrument within the scope of the present invention. The leg connector 654 may be adhered to the writing instrument 601 using adhesive or in other ways, or the sleeve may be selectively removable from the instrument, such as by sliding the sleeve on and off the shaft 608. It is understood that the leg connector 654 may also be formed integrally with the writing instrument 601, such as shown in FIGS. 22-32.

It is contemplated that the leg assembly 652 and other supports of the present invention may be employed on hand-held instruments other than writing instruments to elevate an end of the instrument above a surface. For example, the leg assembly or support may be secured to a toothbrush or razor so that a brush end or a blade end, respectively, does not contact a surface of a bathroom countertop. The leg assembly 652 or support may be removably or fixedly secured to the instrument. The leg assembly 652 or support may have other hinge mechanisms and/or connectors within the scope of the present invention. The leg assembly or support may include or not include an image component within the scope of the invention.

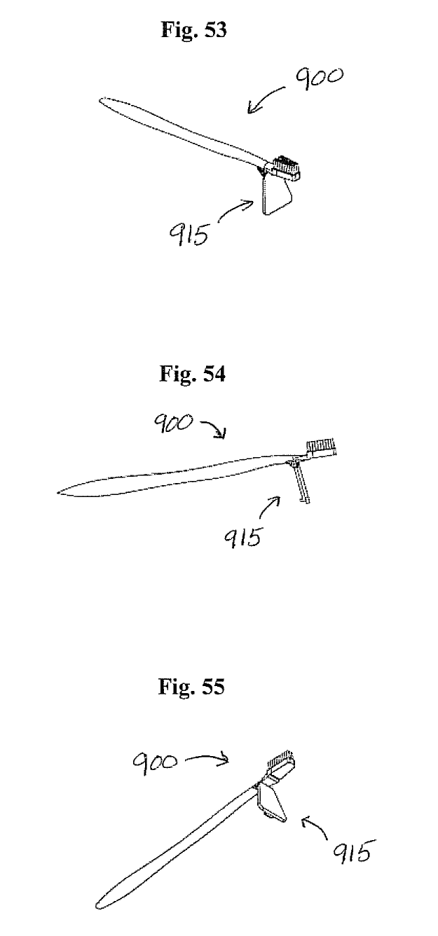

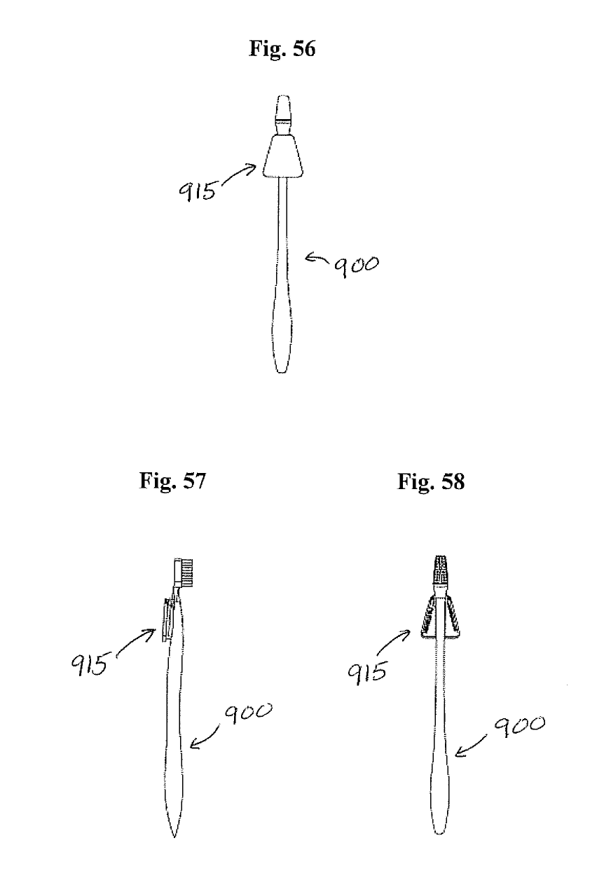

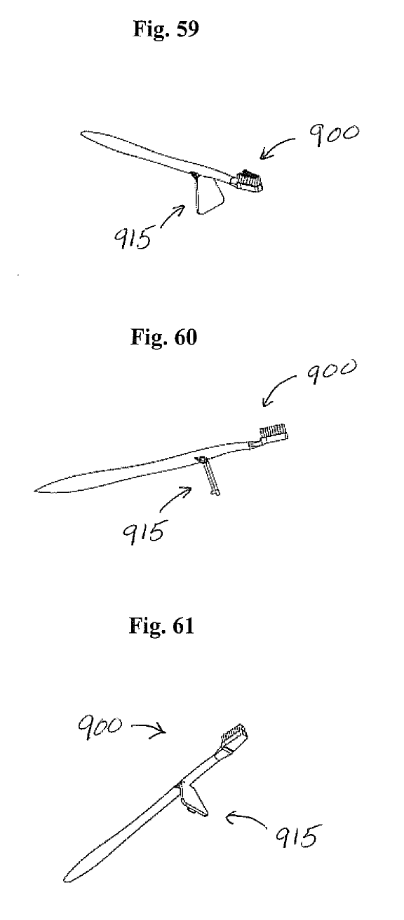

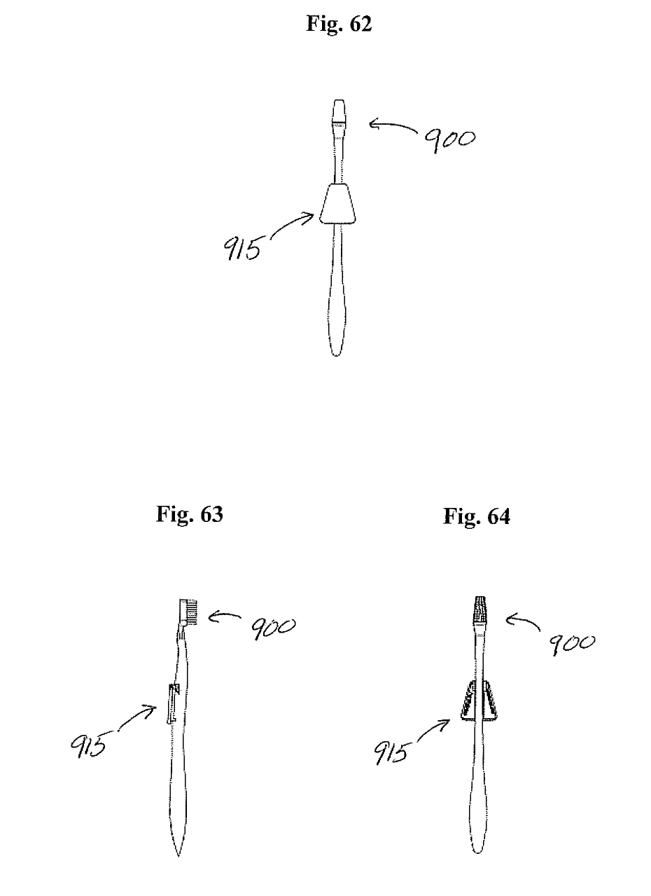

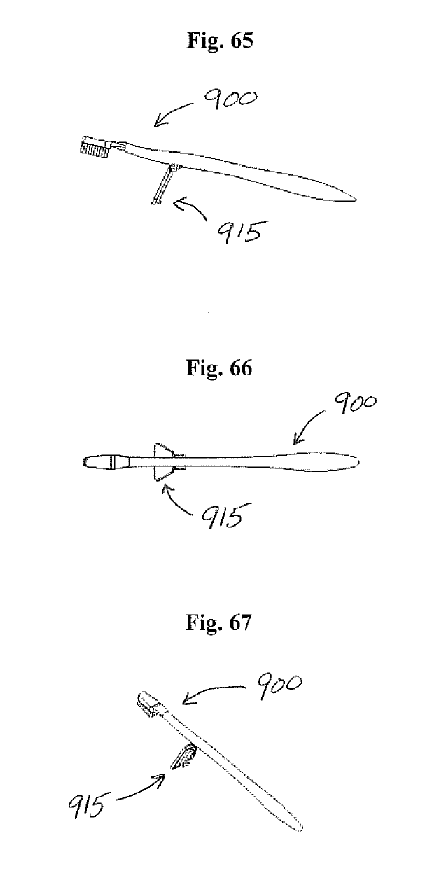

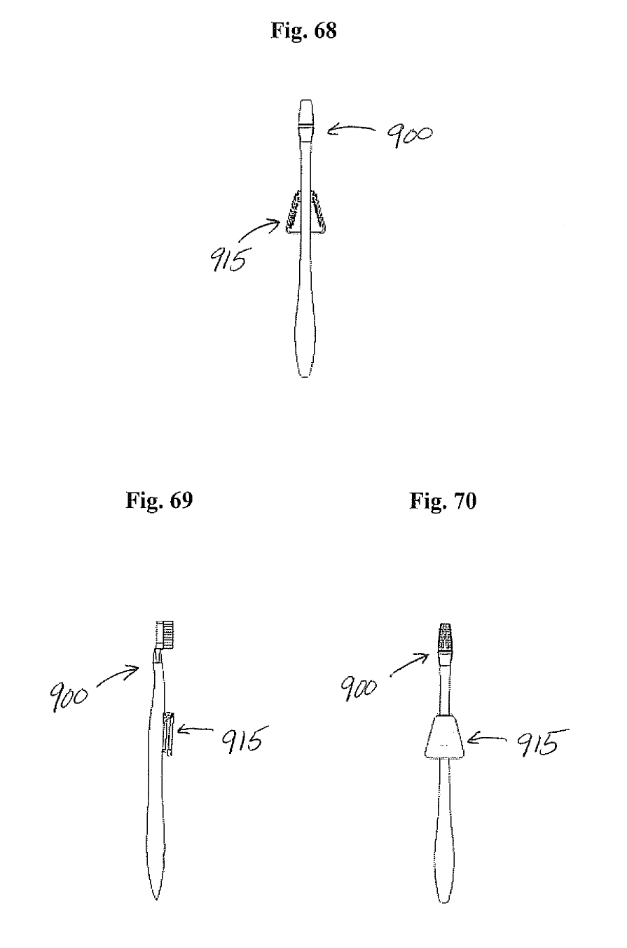

Referring to FIGS. 53-70, a toothbrush 900 may further comprise a support 915 of the present invention. FIGS. 53-64 depict the support 915 disposed on the side of the toothbrush 900 opposite to the bristles. In such a configuration, when the support 915 is in use the bristles of the toothbrush 900 will face away from the surface on which the toothbrush 900 is placed. Such an embodiment is shown in a use configuration in FIGS. 53-55 and 59-61 while shown in a stored configuration in FIGS. 56-58 and 62-64. The support 915 may be disposed at any point along the hand-held instrument. For example, FIGS. 53-58 depict an embodiment having the support 915 disposed adjacent the functional end of the toothbrush 900 while FIGS. 59-64 depict an embodiment having the support 915 disposed closer to the midpoint of the toothbrush 900. In an alternate embodiment, as shown in FIGS. 65-70, the support 915 may be disposed on the toothbrush 900 on the same side as the bristles. In such a configuration, when the support 915 is in use the bristles of the toothbrush 900 will face toward the surface on which the toothbrush 900 is placed. Such an embodiment is shown in a use configuration in FIGS. 65-67 and in a stored configuration in FIGS. 68-70. When the support 915 is transitioning from its use configuration to its stored configuration, the support 915 may pivot toward the bristle end of the toothbrush 900 (not shown), away from the bristle end of the toothbrush 900 (FIGS. 56-58, 62-64, and 68-70), or be capable of both movements. With use of the device in a bathroom, in a preferred embodiment the support 915 may be at least partially coated with an antibacterial material to improve hygiene and/or a rubberized material to enhance gripping. The support 915 may comprise any functional embodiments within the scope of the present invention, and the scope of the invention further includes placement of the support 915 anywhere along the toothbrush 900 not being limited to only the locations shown. The support 915 may be either integrally constructed to the toothbrush 900 or independently constructed and thereafter added onto the toothbrush 900.

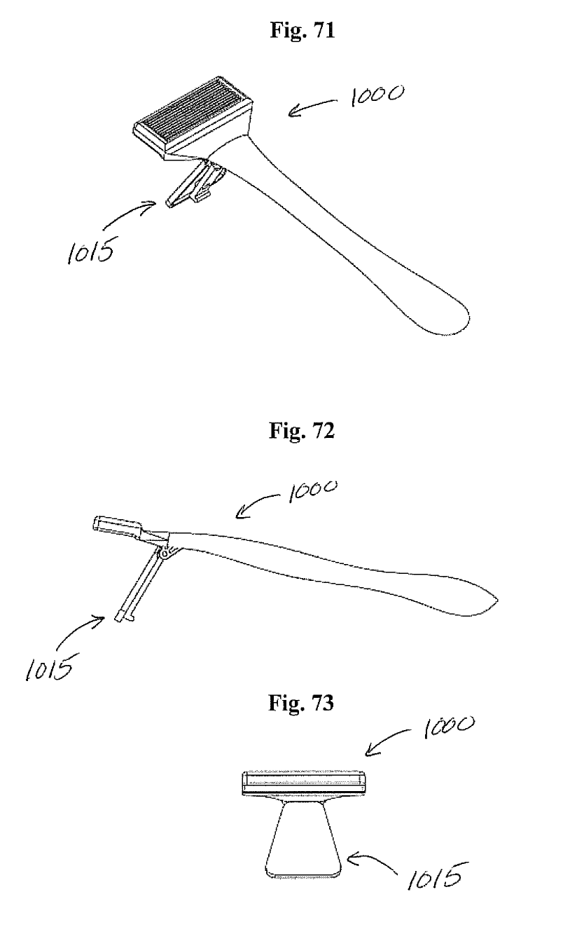

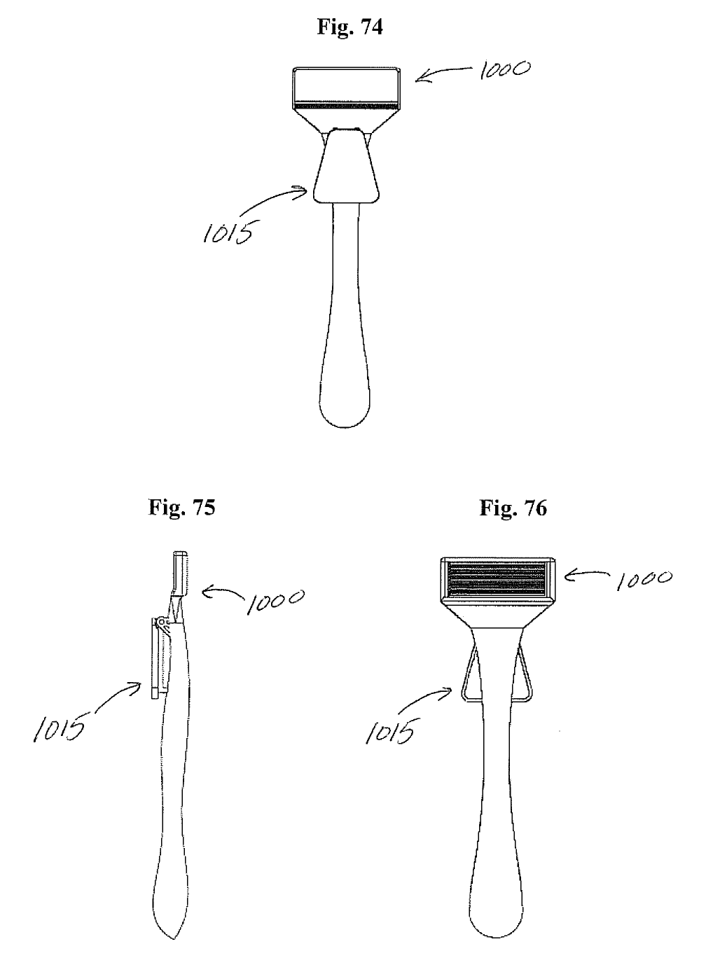

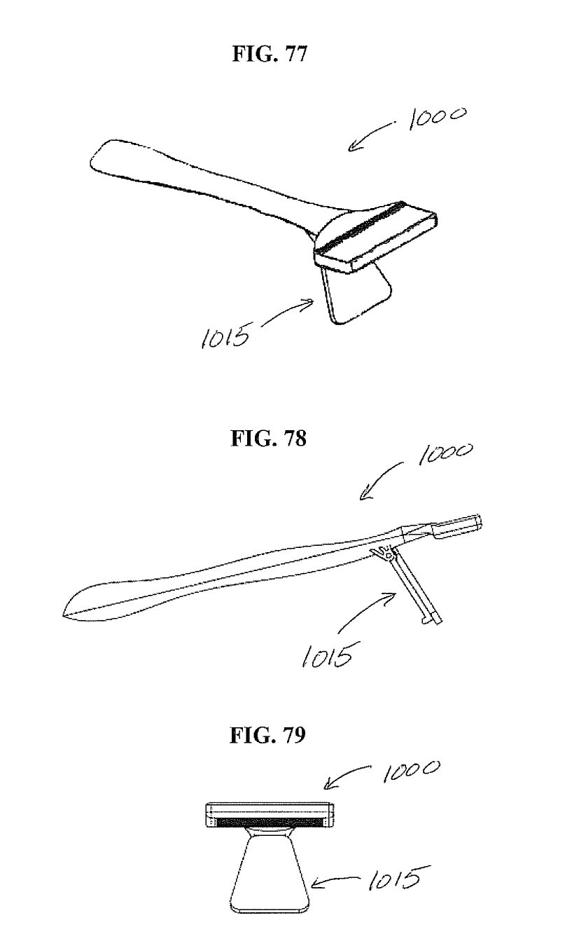

Referring to FIGS. 71-79, a razor 1000 may further comprise a support 1015 of the present invention. FIGS. 71-76 depict the support 1015 disposed on the side of the razor 1000 opposite to the exposed functional blades. In such a configuration, when the support 1015 is in use the exposed functional blades of the razor 1000 will face away from the surface on which the razor 1000 is placed. Such an embodiment is shown in a use configuration in FIGS. 71-73 and in a stored configuration in FIGS. 74-76. In an alternate embodiment, as shown in FIGS. 77-79, the support 1015 may be disposed on the razor 1000 on the same side as the exposed functional blades. In such a configuration, when the support 1015 is in use the exposed functional blades of the razor 1000 will face toward the surface on which the razor 1000 is placed. Such an embodiment is shown in a use configuration in FIGS. 77-79 and a stored configuration is not shown. When the support 1015 is transitioning from its use configuration to its stored configuration, the support 1015 may pivot toward the functional blade end of the razor 1000 (not shown), away from the functional blade end of the razor 1000 (FIGS. 74-76), or be capable of both movements. With use of the device in a bathroom, in a preferred embodiment the support 1015 may be at least partially coated with an antibacterial material to improve hygiene and/or a rubberized material to enhance gripping. The support 1015 may comprise any functional embodiments within the scope of the present invention, and the scope of the invention further includes placement of the support 1015 anywhere along the razor 1000 not being limited to only the locations shown. The support 1015 may be either integrally constructed to the razor 1000 or independently constructed and thereafter added onto the razor 1000.

In the above disclosed embodiments, it may be favorable to have the support integrally formed with the shaft of the hand-held instrument. This may be the case because the additional utility of having the support serve as a clip may not be necessary. It is envisioned that the support can be fashioned to pull out from the handle to serve as a stand for the hand-held instrument and be pushed back into the instrument handle while in use. In such cases, the support may then be disposed parallel to the instrument handle so that the support does not interfere with a user that may be brushing their teeth or shaving. Use in such a configuration is not required. The support allows a user to use the hand-held instrument with the stand in either the open or closed position while not interfering with the user's hand.

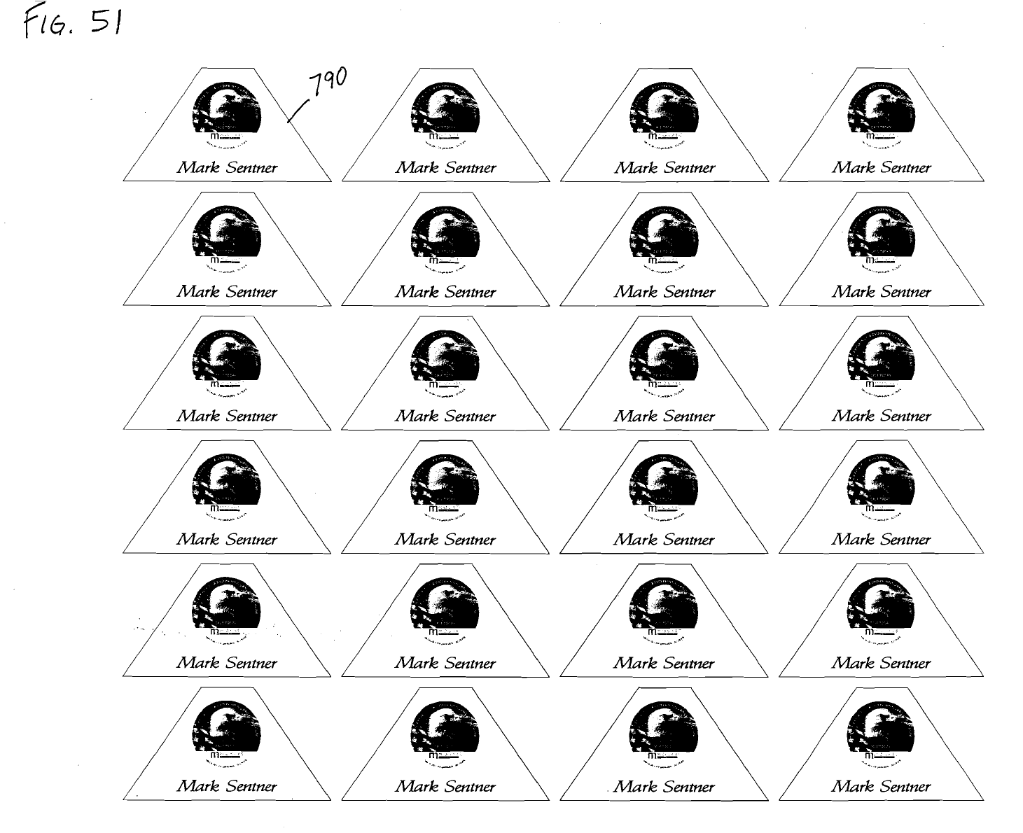

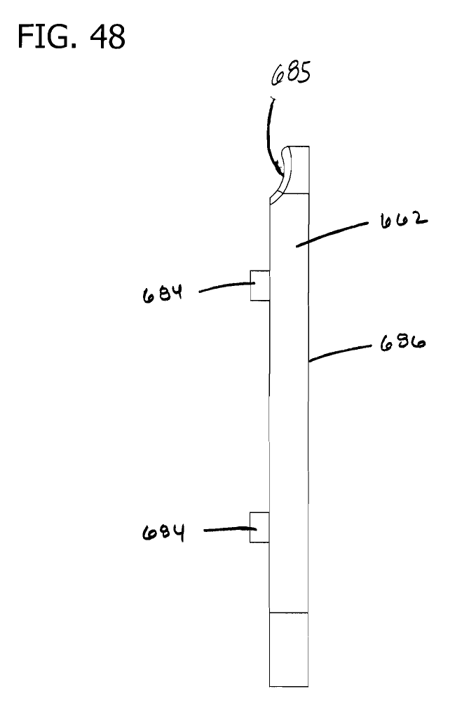

In the illustrated embodiment, the image component 662 is removably secured to the cam lever 660. It is understood that the writing instrument may not include an image on the image component within the scope of the present invention. The image component 662 comprises a plate that is generally triangular having a wide base for resting on a horizontal surface, although other shapes and sizes are within the scope of the invention. As an example, the image component 662 may have a length of about 1.5 in (3.81 cm), a width at its base of about 0.95 in (2.41 cm), a width at its upper portion of about 0.53 in (1.34 cm), and a thickness of about 0.062 in (0.16 cm). An inner face 682 of the component 662, which faces toward the shaft 608 of the writing instrument 601 when the support 615 is in its non-extended position, and an opposing outer face of the cam lever 660 include mateable, releasable snap-fit components 684 for removably securing the image component to the cam lever. Other ways of removably securing the image component 662 to the cam lever 660 are within the scope of the invention. Moreover, it is understood that the image component 662 may be fixedly secured or integrally formed with the cam lever 660 within the scope of the present invention. A clearance groove 685 (FIG. 48) at an upper portion of the image component 662 provides clearance for the arms 658 and the upper portion of the cam lever 660.

The image component 662 includes an outer face 686, which faces away from the shaft 608 of the writing instrument 601 when the support 615 is in its non-extended position. The outer face 686 may include an image, including but not limited to a logo, a design, a drawing and/or a writing that is imprinted or formed on or otherwise affixed to it. The image may cover an entirety of a surface area of the outer face 686, or may cover only a portion thereof The inner face 682 may also include an image, including but not limited to a logo, design, a drawing and/or a writing that is imprinted or formed on or otherwise affixed to it. The image may cover an entirety of a surface area of the inner face 682, or may cover only a portion thereof The disclosure relating to the image feature of the invention disclosed in relation to FIGS. 22-32, above, including a 3-D image, is equally applicable to the present embodiment, although such image is not limited to an advertising image. Neither the outer face 686 nor the inner face 682 of the image component 662 need to include an image to be within the scope of the present invention.

It is envisioned that by making the image component 662 removable from the support 615 (e.g., from the cam lever 660), different, interchangeable image components with different images, can be interchanged on the same writing instrument 601. For example, a user can replace a image component 662 including an image of his/her favorite baseball team with a different image component including an image of his/her favorite football team, without having to replace the entire writing instrument 601. Moreover, a separate market for producing, selling, buying and/or trading different image components 662 is created. It is further envisioned that the image components 662 may include images that depict a mood of the user. Accordingly, on a day in which the user is feeling sad, the user can secure an image component 662 with an image of a sad face to his/her writing instrument 601. Then, when the user is feeling happy, the user can replace the image component with an image component that has an image of a happy face to communicate that the user is feeling happy. Other image components depicting other types of moods are within the scope of the invention.

It is contemplated that all of the components of the illustrated embodiment of FIGS. 33-48 are molded plastic. Other ways of making the components are within the scope of the present invention.

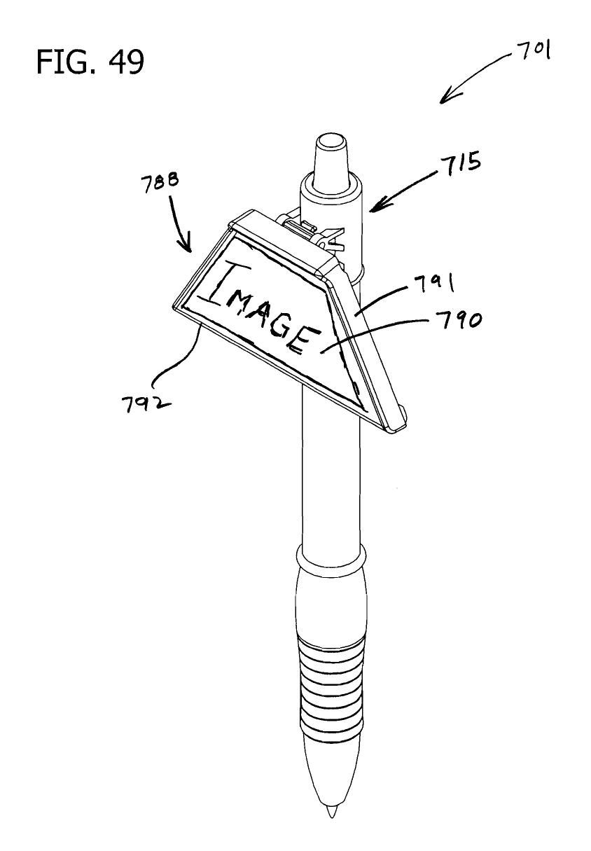

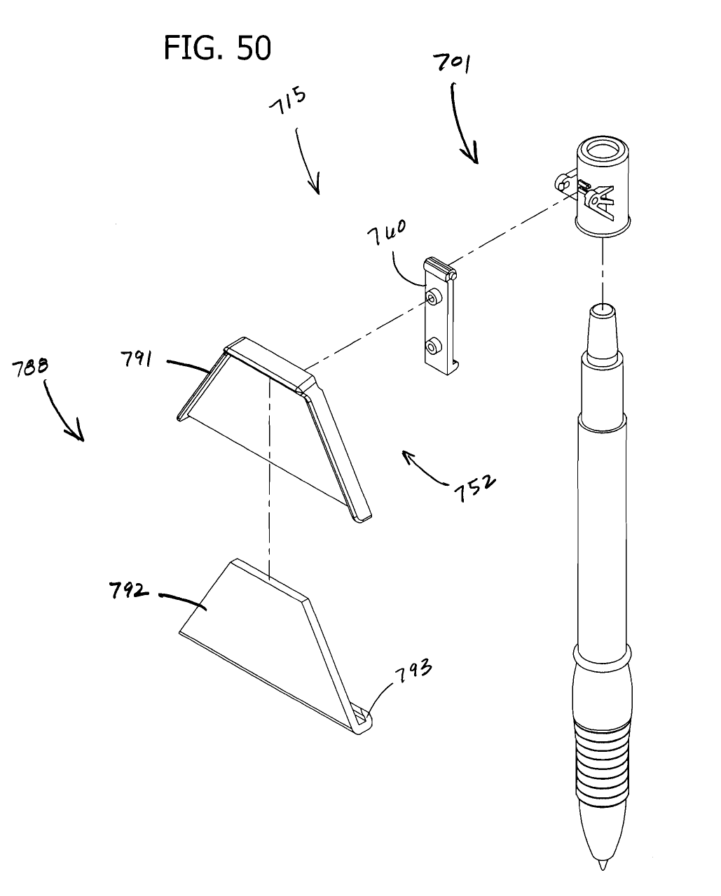

FIGS. 49 and 50 illustrate another embodiment of a writing instrument 701 that is similar to the embodiment of FIGS. 33-48 and has like components indicated by corresponding reference numerals plus 100. In this embodiment, a leg assembly 752 of a support 715 includes an image arrangement comprising an image holder 788 for holding and displaying an image sheet 790 with a logo, a photo, information and/or other images formed on it. This leg assembly 752 has a cam-action hinge mechanism that is the same as the hinge mechanism of the previous embodiment in FIGS. 33-48. It is understood that the leg assembly 752 may have other hinge mechanisms within the scope of the invention. The holder 788 includes a backing 791 secured to a cam lever 760, although it is understood that the backing may be integrally formed with the cam lever or other hinge structure. The backing 791 may be translucent or transparent. A translucent or transparent cover 792 is removably secured to the backing by sliding the cover onto the backing and engaging the backing with a snap-fit or friction-fit component 793 located at a lower portion of the cover. Other ways of securing the cover to the backing are within the scope of the invention.

The image sheet 790 is placed between the backing 791 and the cover 792 (FIG. 49) so that the image is viewable at least through the cover. As an example, the image may be a business logo, a personal photo, a person's name, a business-card-like image, or other information. If the backing 791 is transparent or translucent, then the image sheet 790 may have an image on the front and the back of the sheet. The image sheet 790 is replaceable by sliding the cover 792 off the backing 791 and inserting a new image sheet with an image on it between the cover and the backing and reattaching the cover. The image holder may be of other configurations.

In one example, when the instrument 701 is placed on the table it shows the user's name and logo through the cover 792 and may show contact information through the backing 791 if the backing is transparent or translucent. It is envisioned that a writing instrument 701 of the present embodiment will be given to a potential customer or client, and that the user will remove the image sheet 790 (e.g., business-card-like image) and insert an image sheet having a picture of their own choosing. One of ordinary skill will also appreciate that these instruments can be provided at large conferences and used as place markers reserving seats for attendees. Also, the instruments can serve as a nametag when in its retracted position in a shirt pocket.

It is envisioned that a separate market may be created for producing and selling the image sheets 790 that have the proper dimensions for insertion in the holder 788 of the writing instrument 701. For example, it is envisioned that a user can use software to create a desired image on an image sheet 790 of proper dimension. A website may be set up for this purpose of enabling a user to create images by entering information (e.g., name, contact information), selecting desired graphics, and combining these features in a desired format or configuration. For example, FIG. 51 illustrates an 8½ by 11 inch layout of business cards that can be created. It is foreseen that a 1/32 inch gutter for bleeding of colors may be required or possibly even up to a ¼ inch gutter around all four sides of the sheet. Certain dies will cut 11×17, 12×18, 40×35, 36×40. It is also envisioned that a company may create a commercially available product where a user may pick up a box of cards that are perforated and print from their home computer the business cards.

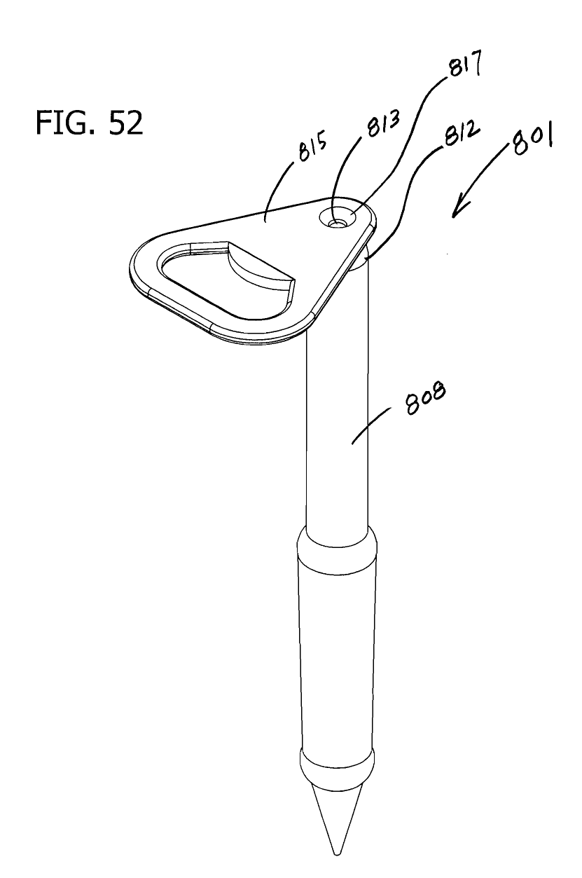

Referring to FIG. 52, another embodiment of a writing instrument is generally indicated at 801. In this embodiment, a bottle cap opener 815 is fixedly secured to a rear end 812 of a shaft 808 of the writing instrument 801. The bottle cap opener extends generally radially outward with respect to a longitudinal axis of the shaft 808. In one example, the opener extends outward at an angle that is generally orthogonal to the axis of the shaft 808. The opener 815 may extend at other angles with respect to the axis of the shaft 808. A fastener 813 extends through an opening 817 in the bottle cap opener and extends axially through the rear end 812 of the shaft 808 to secure the opener to the instrument 801. Other ways of securing the bottle cap opener 815 to the writing instrument 808 are within the scope of the invention. Moreover, the bottle cap opener 815 may be secured to other hand-held instruments besides writing instruments within the scope of the invention.

Having described embodiments of the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A support for a hand-held instrument, said support comprising:
an image holder for releasably retaining an image sheet in said image holder, wherein said image hold is movable with respect to said hand-held instrument;
a pivotal connection disposed between said image holder and said hand-held instrument, wherein said pivotal connection allows said image holder to move from a non-extended position to an extended position in which said image holder projects outward away from said hand-held instrument for contact with a surface on which said hand-held instrument is placed thereby to support said hand-held instrument in a position in which a portion of said hand-held instrument is spaced away from said surface.

2. The support for a hand-held instrument of claim 1, wherein said image holder comprises:
a backing in communication with said pivotal connection; and
a cover releasably securable to said backing, wherein said cover is transparent or translucent and said image sheet may be releasably retained between said backing and said cover.

3. The support for a hand-held instrument of claim 2, wherein said backing is transparent or translucent.

4. The support for a hand-held instrument of claim 2, wherein said cover further comprises a snap fit or friction fit with said backing.

5. The support for a hand-held instrument of claim 4, wherein said snap fit of said cover is disposed on a portion of said cover disposed distal to said pivotal connection.

6. The support for a hand-held instrument of claim 1, wherein said image sheet displays indicia on at least one side of said image sheet, said indicia selected from the group consisting of a logo, a photograph, and text.

7. The support for a hand-held instrument of claim 1, wherein said image sheet displays indicia on two sides of said image sheet, said indicia selected from the group consisting of a logo, a photograph, and text.

8. The support for a hand-held instrument of claim 1, wherein said pivotal connection is integrally formed with said hand-held device.

9. The support for a hand-held instrument of claim 1, further comprising:
a sleeve wherein said pivotal connection is integrally formed with said sleeve, said sleeve is sized to fit about said hand-held device, and said sleeve is releasably securable to said hand-held device.

10. The support for a hand-held instrument of claim 1, further comprising:
a cam lever disposed between said image holder and said pivotal connection, said cam lever having a releasable connection to said image holder and said cam lever further comprising pins for communicating with said pivotal connection.

11. The support for a hand-held instrument of claim 10, wherein said releasable connection between said cam lever and said image holder comprises snap fit components.

12. The support for a hand-held instrument of claim 2, further comprising:
a cam lever disposed between said backing and said pivotal connection, said cam lever having a releasable connection to said backing and said cam lever further comprising pins for communicating with said pivotal connection.

13. The support for a hand-held instrument of claim 12, wherein said releasable connection between said cam lever and said backing comprises snap fit components.

14. The support for a hand-held instrument of claim 1, wherein said pivotal connection comprises:
a cam-action hinge mechanism about which said image holder is pivotal with respect to said hand-held instrument, said cam-action hinge mechanism being configured to resist pivotal movement of said image holder away from said hand-held instrument when said image holder is in said non-extended position and to resist pivotal movement of said image holder toward said hand-held instrument when said image holder is in said extended position.

15. A support for a hand-held instrument, said support comprising:
an image holder for releasably retaining an image sheet in said image holder, wherein said image hold is movable with respect to said hand-held instrument, said image holder further comprising:
a backing; and
a cover releasably securable to said backing, wherein said cover is transparent or translucent, said image sheet is releasably retained between said backing and said cover, and said cover further comprises a snap fit with said backing disposed on a portion of said cover distal to said hand-held instrument;
a pivotal connection integrally formed with said hand-held instrument and in communication with said backing, wherein said pivotal connection allows said backing to move from a non-extended position to an extended position in which said backing projects outward away from said hand-held instrument for contact with a surface on which said hand-held instrument is placed thereby to support said hand-held instrument in a position in which a portion of said hand-held instrument is spaced away from said surface.

16. The support for a hand-held instrument of claim 15, wherein said backing is transparent or translucent and said image sheet displays indicia on two sides of said image sheet, said indicia selected from the group consisting of a logo, a photograph, and text.

17. The support for a hand-held instrument of claim 15, further comprising:
a cam lever disposed between said backing and said pivotal connection, said cam lever having a releasable connection to said backing and said cam lever further comprising pins for communicating with said pivotal connection.

18. A support for a hand-held instrument, said support comprising:
an image holder for releasably retaining an image sheet in said image holder, wherein said image hold is movable with respect to said hand-held instrument, said image holder further comprising:
a backing; and
a cover releasably securable to said backing, wherein said cover is transparent or translucent, said image sheet is releasably retained between said backing and said cover, and said cover further comprises a snap fit with said backing disposed on a portion of said cover distal to said hand-held instrument;
a sleeve sized to fit about said hand-held device, wherein said sleeve is releasably securable to said hand-held device; and
a pivotal connection integrally formed with said sleeve and in communication with said backing, wherein said pivotal connection allows said backing to move from a non-extended position to an extended position in which said backing projects outward away from said hand-held instrument for contact with a surface on which said hand-held instrument is placed thereby to support said hand-held instrument in a position in which a portion of said hand-held instrument is spaced away from said surface.

19. The support for a hand-held instrument of claim 18, wherein said backing is transparent or translucent and said image sheet displays indicia on two sides of said image sheet, said indicia selected from the group consisting of a logo, a photograph, and text.

20. The support for a hand-held instrument of claim 18, further comprising:
a cam lever disposed between said backing and said pivotal connection, said cam lever having a releasable connection to said backing and said cam lever further comprising pins for communicating with said pivotal connection.
